(19) United States
(12) Patent Application Publication
(10) Pub. No.: US 2007/0019959 A1
(43) Pub. Date: Jan. 25, 2007

(54) APPARATUS AND METHOD FOR TRANSFERRING SIGNALS BETWEEN A FIBER NETWORK AND A WIRELESS NETWORK ANTENNA

(75) Inventors: Francis E. Retnasothie, Markham (CA); Sugunalan Muthulingam, Toronto (CA); Dashaini Victoria Retnasothie, Markham (CA)

Correspondence Address: LANG MICHENER LLP, BCE PLACE, SUITE 2500, 181 BAY STREET, TORONTO, ON, M5J 2T7, CA

(73) Assignee: LOGUS Broadband Wireless Solutions Inc., Toronto (CA)

(21) Appl. No.: 11/383,270

(22) Filed: May 15, 2006

Related U.S. Application Data
(60) Provisional application No. 60/700,349, filed on Jul. 19, 2005.

(51) Int. Cl. H04B 10/00

(52) U.S. Cl. 398/115; 370/535; 370/335

(57) ABSTRACT

An apparatus and method transfers signals between a fiber network and a wireless network antenna. In a fiber to wireless stage, fiber signals are optically transferred from the fiber network and converted into RF signals compatible with the DOCSIS interface standard. The RF signals are electronically converted into data packets, the data packets are electronically converted into baseband digital signals, and the digital signals are converted into analog signals, before being transferred to the network antenna for wireless transmission. The data packets, digital signals, and analog signals are compatible with the IEEE 802.l6 wireless networking standard. Conversely, in a wireless to fiber stage, the analog signals are transferred from the antenna, and converted into digital signals, which are then electronically converted into data packets. The data packets are electronically converted into RF signals, which are next converted into fiber signals, before being optically transferred to the fiber network.

### FIELD OF THE INVENTION

The present invention relates to the field of signal transfer between fiber and wireless networks, and more particularly, to an apparatus and method for transferring signals between a hybrid fiber coaxial system and a WiMAX wireless network antenna.

### BACKGROUND OF THE INVENTION

WiMAX is an acronym that stands for Worldwide Interoperability for Microwave Access, and it relates to products that provide point-to-multipoint broadband wireless access and conform with the IEEE 802.16 protocol. Whereas the wireless coverage associated with earlier protocols (e.g., Wi-Fi or IEEE 802.11) has been measured in square meters, WiMAX wireless coverage has the potential to be measured in square kilometers, and proponents of the IEEE 802.16 standard contemplate wireless coverage of entire metropolitan areas (i.e., Wireless Metropolitan Area Networks or WMANs). The WiMAX specification provides for significantly increased bandwidth and stronger encryption in comparison to other wireless standards.

There are a number of significant differences between existing Wi-Fi networks according to the IEEE 802.11 standard) and the WiMAX systems that are currently contemplated (according to the IEEE 802.16 standard). Perhaps foremost of these differences is that, while the MAC layer in a Wi-Fi network uses contention access, WiMAX networks shall include a scheduling MAC layer. In Wi-Fi contention access systems, all subscriber stations wishing to pass data through a wireless access point must compete for the wireless access point's attention on a substantially random basis, which can cause nodes distant from the wireless access point to be repeatedly interrupted by less sensitive closer nodes, thus greatly reducing the throughput of such distant nodes. By contrast, the scheduling MAC layer that is to be used in WiMAX networks will be such that each subscriber station will only have to compete once (for initial entry into the WiMAX network), thereafter being allocated a time slot in a queue by the WiMAX base station. The time slot can enlarge and constrict, but it remains assigned to hat subscriber station-meaning that other subscribers are not able to use it, but must take their turn. Unlike Wi-Fi (802.11) networks, the scheduling algorithm of WiMAX (802.16) networks will be stable under overload and oversubscription conditions. The WiMAX (802.16) scheduling algorithm is intended to provide improved bandwidth efficiency, and to allow the WiMAX base station to control quality of service by balancing the assignments among the needs of the various subscriber stations.

Another significant difference between Wi-Fi and WiMAX networks is that, while Wi-Fi channels occupy a fixed width of the spectrum, the channels of WiMAX networks are permitted to get narrower and to occupy a smaller range of the spectrum. In this manner (i.e., by providing narrower channels that each use less bandwidth), WiMAX systems might potentially serve a significantly increased number of users. That is, the same amount of bandwidth might be organized into fixed size Wi-Fi channels or into a significantly larger number of WiMAX channels, thus potentially enabling the provision of services to more subscribers.

Another difference between Wi-Fi and WiMAX systems is that licensed spectrum may be used to deliver WiMAX. Whereas all Wi-Fi technology has to date been delivered in unlicensed spectrum, and while WiMAX networks might likewise use unlicensed frequencies, WiMAX systems could also be set up that use licensed frequencies. The use of licensed frequencies would enable increased output power and broadcasts over longer distances. Once again, therefore, while Wi-Fi networks are typically measured in meters, WiMAX networks would typically have good value proposition and bandwidth up to several kilometers or more.

The most recent versions of the WiMAX IEEE 802.16 standards provide support substantially in the ≦66 GHz range. The WiMAX standard provides for shared data rates of up to 70 Mbps, which is presently enough bandwidth to simultaneously support a large number of businesses and homes.

Moreover, extending services using coaxial cables and fiber optic cables can require significant infrastructure builds and upgrades. Similarly, costs for such coaxial cable and fiber optic cable implementation are on the rise.

Additionally, while it may be known to provide fiber to Wi-Fi interconnectivity, what is needed is an apparatus and a method to provide fiber to WiMAX Interconnectivity, and provide broadband, secure, mobile connectivity to end subscribers.

Cable, cellular and traditional telephone companies could all stand to benefit from developments that might make use of the WiMAX wireless networking standard. Thus far, in the prior art, there are no known systems specifically adapted to enable the use of WiMAX networks for “last mile” connectivity (i.e., from a neighborhood distribution node to an end subscriber). What is needed, therefore, is a system whereby WiMAX antennae might; be connected to a service provider's “head end” via a light fiber optics cable.

With proper integration, cable operators might be able to extend services to un-serviced and under serviced areas, which are not reachable today. The WiMAX standard has the capability to provide broadband, secured services at low cost.

It is an object of the invention to provide cable operators with a method and apparatus that is suitable to extend services to un-serviced and under serviced areas, which are not reachable today.

In order to fulfill consumer demand and/or improve broadband access and/or connectivity, and/or for various other reasons, there may also be a need, in the prior art, for WiMAX base stations and subscriber stations.

The WiMAX (802.16) wireless networking standard might support many wireless-broadband connections for home and small-business users, backhaul networks for cellular base stations, and backhaul connections to the Internet for Wi-Fi hot spots. Using non-line-of-sight propagation, products like laptops, PDAs, and cell phones might deliver services directly to the end users in a point-to-multipoint architecture.

It is an object of the invention to provide an apparatus and method that interconnect the optical fibers or coaxial cables of HFC systems with a fixed, mobile air interface of a WiMAX network.

It is a further object of the invention to provide an apparatus that is capable of transferring signals from HFC systems, DOCSIS and other similar protocols (in addition to GigE and ATM) to a WiMAX air interface.

It is a still further object of the invention that these transferred WiMAX signals would be suitable for reception by subscriber units, both fixed and mobile, and for conversion back to their original packet formats.

It is yet another object of the invention to provide an apparatus that might also follow the same principles when operating along a reverse pathway.

It is a further object of the invention to provide an apparatus and method for extending service infrastructure, at a relatively low cost in comparison to coaxial or fiber implementation.

It is an object of the invention to provide an apparatus and method that enables integration between hybrid fiber coaxial systems and WiMAX networks.

It is another object of the invention to provide an apparatus and method that enables interface between DOCSIS signals and an orthogonal frequency division multiplexing (OFDM) PHY interface for broadband connectivity.

It is a further object of the invention to provide an apparatus and method that enables coverage of licensed and license exempt bands and/or frequencies.

It is a yet further object of the Invention to provide an apparatus and method that might be adapted to include software defined radio elements.

It is still another object of the invention to provide an apparatus and method that support mobility (via the IEEE 802.16e and IEEE 802.16-2004 specifications).

It is yet another object of the invention to provide an apparatus that includes a multiplexer at a base station thereof that supports the DOCSIS, GigE and ATM standards.

It is an object of the invention to provide an apparatus and method that provides secure interconnectivity and transmission of data (via the IEEE 802.16e and IEEE 802.16-2004 specifications).

It is a further object of the Invention to provide an apparatus and method that supports very long range coverage through WiMAX implementation (and preferably one that enables mobile implementation over a range substantially in the order of 2-3 km, whilst also enabling fixed line-of-sight (LOS) and fixed non-line-of-sight (NLOS) implementation over a range substantially in the order of 10-30 km, via the IEEE 802.16e specification and/or via other prior and contemplated versions of the IEEE 802.16 specification).

It is still another object of the invention to provide an apparatus and method that supports seamless integration of the WiMAX standard with existing protocols and that extends current and future data services to under-served areas in a cost-effective way.

### SUMMARY OF THE INVENTION

In accordance with the present invention there is disclosed an apparatus for transferring signals between a fiber network and a wireless network antenna. The fiber network includes fiber optic cables and utility poles. The apparatus includes a fiber module, an RF/packet converter, a WIMAX media access control layer, a baseband physical layer, and a radio module. The fiber module is adapted to be operatively coupled to the fiber network so as to enable transfer of fiber signals to and from the fiber network. The fiber module includes a fiber module conversion means for converting between the fiber signals and RF signals in a bidirectional radio frequency format compatible with the DOCSIS interface standard. The RF/packet converter is in RF communicating relation with the fiber module so as to enable bidirectional transfer of the RF signals to and from the fiber module. The RF/packet converter includes at least one signal processor that is adapted to convert between the RF signals and data packets in a packet format compatible with the IEEE 802.16 wireless networking standard. The WIMAX media access control layer is in packet communicating relation with the RF/packet converter so as to enable transfer of the data packets to and from the RF/packet converter. The WIMAX media access control layer includes at least one WIMAX MAC processor which is adapted to bidirectionally convert between the data packets and bit stream signals in a bit stream format that is compatible with the IEEE 802.16 wireless networking standard. The baseband physical layer is in bit stream communicating relation with the WIMAX media access control layer so as to enable operative transfer of the bit stream signals to and from the WiMAX media access control layer. The baseband physical layer includes a PHY processor which is adapted to bidirectionally convert between the bit stream signals and baseband digital signals in a baseband digital formats compatible with the IEEE 802.16 wireless networking standard. The radio module is in baseband digital communicating relation with the baseband physical layer so as to enable transfer of the baseband digital signals to and from the baseband physical layer. The radio module includes a radio module conversion means for converting between the baseband digital signals and analog signals in an analog format compatible with the IEEE 802.16 wireless networking standard. The radio module is adapted to be operatively coupled to the wireless network antenna so as to enable transfer of the analog signals to and from the wireless network antenna. The apparatus operatively transfers signals between the fiber network and the wireless network antenna in a fiber to wireless stage and in a wireless to fiber stage. In the fiber to wireless stage, (i) the fiber module transfers the fiber signals from the fiber network, (ii) the fiber module conversion, means converts the fiber signals into the RF signals, (iii) the RF/packet converter transfers the RF signals from the fiber module, (iv) the aforesaid at least one signal processor converts the RF signals into the data packets, (v) the WiMAX media access control layer transfers the data packets from the RF/packet converter, (vi) the aforesaid at least one WIMAX MAC processor converts the data packets into the bit stream signals, (vii) the baseband physical layer transfers the bit stream signals from the WIMAS Media access control layer, (viil) the PHY processor converts the bit stream signals into the baseband digital signals, (ix) the radio module transfers the baseband digital signals from the baseband physical layer, (x) the radio module conversion means converts the baseband digital signals into the analog signals, and (xi) the radio module transfers the analog signals to the wireless network antenna for transmission according to the IEEE 802.16 wireless networking standard. In the wireless to fiber stage, (i) the radio module transfers the analog signals from the wireless network antenna according to the IEEE 802.16 wireless networking standard, (ii the radio module conversion means converts the analog signals into the baseband digital signals, (iii) the radio module transfers the baseband digital signals to the baseband physical layer, (iv) the PHY processor converts the baseband digital signals into the bit stream signals and (v) the baseband physical layer transfers the bit stream signals to the WIMAX media access control layer, (vi) the aforesaid at least one WIMAX MAC processor converts the bit stream signals into the data packets and (vii) the WIMAX media access control layer transfers the data packets to the RF/packet converter, (viii) the aforesaid at least one signal processor converts the data packets into the RF signals, (ix) the RF/packet converter transfers the RF signals to the fiber module, (x) the fiber module con version means converts the RF signals into the fiber signals, and (xi) the fiber module transfers the fiber signals to the fiber network.

According to an aspect of a preferred embodiment of the invention, the at least one signal processor of the RF/packet converter includes a DOCSIS/Ethernet converter and an Ethernet MAC processor. The DOCSIS/Ethernet converter is preferably in the aforesaid RF communicating relation with the fiber module. The DOCSIS/Ethernet converter is preferably adapted to convert between the RF signals and Ethernet signals in a bidirectional interface format that is compatible with the IEEE 802.3 standard. The Ethernet MAC processor is preferably in Ethernet communicating relation with the DOCSIS/Ethernet converter so as to enable operative bidirectional transfer of the Ethernet signals to and from the DOCSIS/Ethernet converter. The Ethernet MAC processor is preferably adapted to convert between the Ethernet signals and the data packets in the aforesaid packet format. Preferably, in the fiber to wireless stage, (i) the DOCSIS/Ethernet converter transfers the RF signals from the fiber module and (ii) converts the RF signals into the Ethernet signals, (iii) the Ethernet MAC processor transfers the Ethernet signals from the DOCSIS/Ethernet converter and (iv) converts the Ethernet signals into the data packets, and (v) the WIMAX media access control layer transfers the data packets from the Ethernet MAC processor. Preferably, in the wireless to fiber stage, and on the other hand, (i) the WIMAX media access control layer transfers the data packets to the Ethernet MAC processor, (ii) the Ethernet MAC processor converts the data packets into the Ethernet signals and (iii) transfers the Ethernet signals to the DOCSIS/Ethernet converter, and (iv) the DOCSIS/Etherrnet converter converts the Ethernet signals into the RF signals and (v) transfers the RF signals to the fiber module.

According to another aspect of the preferred embodiment of the invention, the RF/packet converter, the WIMAX media access control layer, and the baseband physical layer may preferably be together formed on a single circuit board, and may still more preferably be formed on a single integrated circuit on the circuit board.

According to another aspect of the preferred embodiment of the invention, the apparatus may preferably further include an enclosure. Preferably, the fiber module, the RF/packet converter, the WIMAX media access control layer, the baseband physical layer, and the radio module may be together contained within the enclosure. The enclosure may preferably be a rugged enclosure that is adapted for outdoor use so as to substantially protect components therein from outside environmental conditions. The rugged enclosure may also or alternately preferably have a rigid watertight shell so as to substantially protect components therein from outside underground conditions.

According to another aspect of the preferred embodiment of the invention, the fiber module may preferably include a RF diplexer having a transmission path, a reception path, and a combined signal path in the aforesaid RF communicating relation with the RF/packet converter. The fiber module conversion means may preferably include a RF transmitting module and a RF receiving module. The RF transmitting module may preferably be coupled to the transmission path of the RF diplexer. The RF transmitting module may preferably be adapted to be operatively coupled to the fiber network. Preferably, in the fiber to wireless stage, (i) the RF transmitting module transfers the fiber signals from the fiber network, (ii) converts the fiber signals into the RF signals, and (iii) transmits the RF signals to the transmission path of the RF diplexer, with (iv) the RF diplexer transmitting the RF signals along the combined signal path to the RF/packet converter. The RF receiving module may preferably be coupled to the reception path of the RF diplexer. The RF receiving module may preferably be adapted to be operatively coupled to the fiber network. Preferably, in the wireless to fiber stage, (i) the RF/packet converter transmits the RF signals to the combined signal path of the RF diplexer, (ii) the RF diplexer transmits the RF signals along the reception path to the RF receiving module, (iii) the RF receiving module converts the RF signals into the fiber signals, and (iv) transfers the fiber signals to the fiber networks

According to another aspect of the preferred embodiment of the invention, the RF transmitting module may preferably include an optical receiving diode that is adapted to be optically coupled to the fiber network so as to enable, in the fiber to wireless stage, the aforesaid transfer of the fiber signals from the fiber network. The RF transmitting module may more preferably also include a band pass filter coupled to a diode output preferably of the optical receiving diode. A first amplifier may preferably be coupled to a filtered output path of the band pass filter. An attenuator may preferably be coupled to a first amplified output path of the first amplifier A second amplifier may preferably be coupled to an attenuated output path of the attenuator. The transmission path of the RF diplexer may preferably be coupled to a second amplified output path of the second amplifier so as to enable, in the fiber to wireless stage, the aforesaid transmission of the RF signals from the RF transmitting module to the RF/packet converter.

According to another aspect of the preferred embodiment of the invention, the RF receiving module may preferably include an optical transmitting diode that may preferably be adapted to be optically coupled to the fiber network so as to enable, in the wireless to fiber stage, the aforesaid transfer of the fiber signals to the fiber network. The RF receiving module may more preferably include a first attenuator coupled to the reception path of the RF diplexer so as to enable, in the wireless to fiber stage, the aforesaid reception by the RF receiving module of the RF signals from the RF/packet converter. An amplifier may preferably be coupled to a first attenuated output path of the first attenuator. A second attenuator may preferably be coupled to an amplified output path of the amplifier. The optical transmitting diode may preferably be coupled to a second attenuated output path of the second attenuator.

According to another aspect of the preferred embodiment of the invention, the radio module conversion means may preferably include a radio transmitting module and a radio receiving module. The radio transmitting module may preferably be coupled to the baseband physical layer in the aforesaid baseband digital communicating relation. The radio transmitting module may preferably be adapted to be operatively coupled to the wireless network antennae Preferably, in the fiber to wireless stage, (i) the radio transmitting module transfers the baseband digital signals from the baseband physical layer, (ii) converts the baseband digital signals into the analog signals, and (iii) transfers the analog signals to the wireless network antenna. The radio receiving module may preferably be coupled to the baseband physical layer in the aforesaid baseband digital communicating relations. The radio receiving module may preferably be adapted to be operatively coupled to the wireless network antenna. Preferably, in the wireless to fiber stage, (i) the radio receiving module transfers the analog signals from the wireless network antenna, (ii) converts the analog signals into the baseband digital signals, and (iii) transfers the baseband digital signals to the baseband physical layer.

According to another aspect of the preferred embodiment of the invention, one or more of the radio transmitting module and the radio receiving module may preferably, but need not necessarily, be embodied in a software defined radio. According to another aspect of one embodiment of the invention, one or more of the radio transmitting module and the radio receiving module may preferably, but need not necessarily, be embodied both in hardware and in a software defined radio.

According to another aspect of the preferred embodiment of the invention, the radio module may preferably be include an antenna diplexer/switch having a transmission path, a reception path, and a combined signal path that may preferably be adapted to be operatively coupled to the wireless network antenna. The radio transmitting module may preferably be coupled to the transmission path of the antenna diplexer/switch for operative transfer of the analog signals to the wireless network antenna in the fiber to wireless stage. The radio receiving module may preferably be coupled to the reception path of the antenna diplexer/switch for operative transfer of the analog signals from the wireless network antenna in the wireless to fiber stage.

According to another aspect of the preferred embodiment or the invention, the radio transmitting module may preferably also include a digital to analog converter that is coupled to the baseband physical layer in the aforesaid baseband digital communicating relation. A first oscillating signal mixer may preferably be coupled to a converted output path of the digital to analog converter. A first amplifier may preferably be coupled to a first mixed output path of the first oscillating signal mixer. A band pass filter may preferably be coupled to a first amplified output path of the first amplifier. A second oscillating mixer may preferably be coupled to a filtered output path of the band pass filter. A power amplifier may preferably be coupled to a second mixed output path of the second oscillating mixer. The transmission path of the antenna diplexer/switch may preferably be coupled to a power amplified output path of the power amplifier so as to enable, in the fiber to wireless stage, the aforesaid operative transfer of the analog signals to the wireless network antenna.

According to another aspect of the preferred embodiment of the invention, the radio receiving module may preferably also include a first band pass filter that may preferably be coupled to the reception path of the antenna diplexer/switch so as to enable the aforesaid transfer of the analog signals from the wireless network antenna. A low noise amplifier may preferably be coupled to a first filtered output path of the first band pass filter. A first oscillating mixer may preferably be coupled to a low noise amplified output path of the low noise amplifier. A second band pass filter may preferably be coupled to a first mixed output path of the first oscillating mixer. A second amplifier may preferably be coupled to a second filtered output path of the second band pass filter. A second oscillating mixer may preferably be coupled to a second amplified output path of the second amplifier. An analog to digital converter may preferably be coupled to a second mixed output path of the second oscillating mixer. The analog to digital converter may preferably be coupled to the baseband physical layer in the baseband digital communicating relation so as to enable, in the wireless to fiber stage, the aforesaid transfer of the baseband digital signals to the baseband physical layer.

According to the invention, there is also disclosed a method of transferring signals between a fiber network and a wireless network antenna. According to a step (a) of the method, the fiber signals are optically transferred to and from the fiber network. The method includes a step (b) of converting between the fiber signals and RF signals in a bidirectional radio frequency format that is compatible with the DOCSIS interface standard. The method includes a step (c) of electronically converting between the RF signals and data packets in a packet format that is compatible with the IEEE 802.16 wireless networking standard. The method includes a step (d) of electronically converting between the data packets and baseband digital signals in a baseband digital format that is compatible with the IEEE 802.16 wireless networking standard. The method includes a step (e) of converting between the baseband digital signals and analog signals in an analog format that is compatible with the IEEE 802.16 wireless networking standard. The method includes a step (f) of transferring the analog signals to and from the wireless network antenna. More particularly, in an operative fiber to wireless stage of the method, (1) the fiber signals are optically transferred from the fiber network, (2) the fiber signals are converted into the RF signals, (3) the RF signals are electronically converted into the data packets, (4) the data packets are electronically converted into the baseband digital signals, (5) the baseband digital signals are converted into the analog signals, and (6) the analog signals are transferred to the wireless network antenna for transmission according to the IEEE 802.16 wireless networking standard. In an operative wireless to fiber stage of the method, on the other hand, (1) the analog signals are transferred from the wireless network antenna according to the IEEE 802.16 wireless networking standard, (2) the analog signals are converted into the baseband digital signals, (3) the baseband digital signals are electronically converted into the data packets, (4) the data packets are electronically converted into the RF signals, (5) the RF signals are converted into the fiber signals, and (6) the fiber signals are optically transferred to the fiber network.

According to another aspect of the preferred embodiment of the invention, the step (c) may preferably include a substep (c.1) of electronically converting between the RF signals and Ethernet signals in a bidirectional interface format compatible with the IEEE 802.3 standard. The step (c) may also preferably include a substep (c.2) of electronically converting between the Ethernet signals and the data packets in the packet format. Preferably, in the operative fiber to wireless stage of the method, 3.1) the RF signals are converted into the Ethernet signals, and (3.2) the Ethernet signals are converted into the data packets, before (4) the data packets are electronically converted into the baseband digital signals. Preferably, in the operative wireless to fiber stage of the method, and on the other hand, (4.1) the data packets are converted into the Ethernet signals, and (4.2) the Ethernet signals are converted into the RF signals, before (5) the RF signals are converted into the fiber signals.

According to another aspect of the preferred embodiment of the invention, in the step (a), optical diodes may preferably optically transfer the fiber signals to and from the fiber network. Before the step (a), the method may preferably include an additional step (i) of optically coupling the optical diodes to at least one fiber optic cable of the fiber network, and a further additional step (ii) of suspending the enclosure from at least one supporting member selected from, the group consisting of a utility pole and the at least one fiber optic cable.

According to another aspect of the preferred embodiment of the invention, in the step (c), a RF/packet converter may preferably electronically convert between the RF signals and the data packets. In the step (b), a RF diplexer having a transmission path, a reception path, and a combined signal path may preferably bidirectionally transfer the RF signals over the combined signal path to and from the RF/packet converter according to the DOCSIS interface standard.

According to another aspect of the preferred embodiment of the invention, in the step (a), a RF transmitting module may preferably transfer the fiber signals from the fiber network in the fiber to wireless stage. In the step (b), the RF transmitting module may preferably convert the fiber signals into the RF signals in the fiber to wireless stage. In the step (b), the RF transmitting module may preferably be coupled to the transmission path of the RF diplexer for transmission of the RF signals to the RF/packet converter in the fiber to wireless stage.

According to another aspect of the preferred embodiment of the invention, in the step (b), the RF signals may preferably be successively filtered, amplified, attenuated, and re-amplified within the RF transmitting module before being transmitted to the transmission path of the RF diplexer, and before transmission of the RF signals to the RF/packet converter in the fiber to wireless stage.

According to another aspect of the preferred embodiment of the invention, in the step (b), a RF receiving module may preferably be coupled to the reception path of the RF diplexer for reception of the RF signals from the RF/packet converter in the wireless to fiber stage. In the step (b), the RF receiving module may preferably convert the fiber signals into the RF signals in the wireless to fiber stage. In the step (a), the RF receiving module may preferably transfer the fiber signals to the fiber network in the wireless to fiber stage.

According to another aspect of the preferred embodiment of the invention, in the step (b), the RF signals may preferably be successively attenuated, amplified, and re-attenuated within the RF receiving module before being converted into the fiber signals and transferred to the fiber network by the optical diode in the wireless to fiber stage.

According to another aspect of the preferred embodiment of the invention, in the step (f), an antenna diplexer/switch having a transmission path, a reception path, and a combined signal path may preferably bidirectionally transfer the analog signals over the combined signal path to and from the wireless network antenna.

According to another aspect of the preferred embodiment of the invention, in the step (d), a PHY processor may preferably electronically convert the data packets into the baseband digital signals. In the step (e), a radio transmitting module may preferably receive the baseband digital signals from the PHY processor in the fiber to wireless stage, and convert the baseband digital signals into the analog signals. In the step (e), the radio transmitting module may preferably transfer the analog signals to the transmission path of the antenna diplexer/switch for transfer, in the step (f), to the wireless network antenna in the fiber to wireless stage.

According to another aspect of the preferred embodiment of the invention, in the step (e) the baseband digital signals may preferably be converted into the analog signals. The analog signals may preferably be successively mixed with a first oscillating signal, amplified, band pass filtered, re-mixed with a second oscillating signal, and power amplified within the radio transmitting module before being transferred to the transmission path of the antenna diplexer/switch in the fiber to wireless stage.

According to another aspect of the preferred embodiment of the invention, in the step (f), the analog signals may preferably be transferred, in the wireless to fiber stage, from the wireless network antenna to the combined signal path of the antenna diplexer/switch. In the step (e), a radio receiving module may preferably transfer the analog signals from the reception path of the antenna diplexer/switch in the wireless to fiber stage. In the step (e), the radio transmitting module may preferably convert the analog signals into the baseband digital signals in the wireless to fiber stage, and transfers the baseband digital signals to a PHY processors In the step (d), the PHY processor may preferably electronically convert the baseband digital signals into the data packets.

According to another aspect of the preferred embodiment of the invention, in the step (e), the analog signals may preferably be transferred, in the wireless to fiber stage, from the reception path of the antenna diplexer/switch to the radio receiving module. The analog signals may preferably be successively filtered through a first band pass filter, low noise amplified, mixed with a first oscillating signal, re-filtered through a second band pass filter, re-amplified, and re-mixed with a second oscillating signal, before being converted into the baseband digital signals within the radio receiving module in the fiber to wireless stage

It is thus an object of this invention to obviate or mitigate at least one of the above mentioned disadvantages of the prior art.

Other advantages, features and characteristics of the present invention, as well as methods of operation and functions of the related elements of the structure, and the combination of parts and economies of manufacture, will become more apparent upon consideration of the following detailed description and the appended claims with reference to the accompanying drawings, the latter of which is briefly described hereinbelow.

### BRIEF DESCRIPTION OF THE DRAWINGS

The novel features which are believed to be characteristic of the apparatus and method according to the present invention, as to its structure, organization, use and method of operation, together with further objectives and advantages thereof, will be better understood from the following drawings in which a presently preferred embodiment of the invention will now be illustrated by way of examples. It is expressly understood, however, that the drawings are for the purpose of illustration and description only, and are not intended as a definition of the limits of the inventions In the accompanying drawings:

FIG. 1 is a depiction of a prior art hybrid fiber coaxial system;

FIG. 2 is a depiction of an apparatus and method according to one preferred embodiment of the invention;

FIG. 3 is a depiction of an apparatus and method according to another preferred embodiment of the invention;

FIG. 4 is a schematic diagram of an apparatus according to the invention;

FIG. 4A is an enlarged view of the portion surrounded by the dotted outline 4A in FIG. 4;

FIG. 4B is an enlarged view of the portion surrounded by the dotted outline 4B in FIG. 4;

FIG. 5 generally depicts a method according to the invention;

FIGS. 6A and 6B depict in greater detail a fiber to wireless stage of the method shown in FIG. 5;

FIGS. 7A and 7B depict in greater detail a wireless to fiber stage of the method shown in FIG. 5;

FIG. 8 shows the apparatus of FIG. 4 suspended within an enclosure from a fiber optic cable of the fiber network; and

FIG. 9 shows the apparatus of FIG. 4 securely encapsulated within an enclosure in an underground environment

### DETAILED DESCRIPTION OF A PREFERRED EMBODIMENT

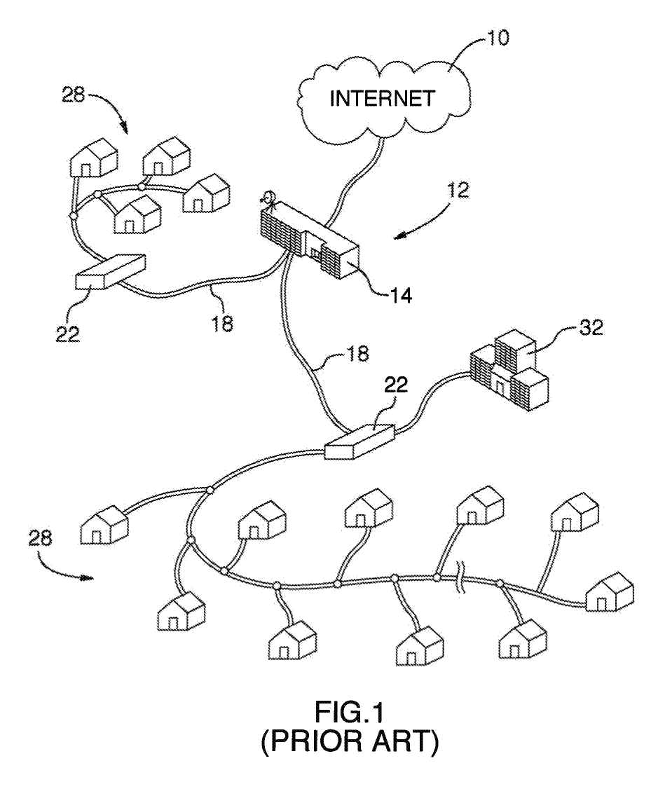

FIG. 1 depicts a prior art fiber network 12 connected to the Internet 10. The prior art network 12 may be a hybrid fiber coaxial (HFC) networks The fiber network 12 shown in FIG. 1 includes a head end cable operator 14 connected by coaxial or fiber optics cables 18 to a plurality of neighborhood distribution nodes 22. Each of the distribution nodes 22 is physically connected via a trunk and branch system of coaxial or fiber optics cables 18 to a large number of home and business subscribers 28, 32 in order to provide such subscribers with network services. That is, the fiber network 2 may generally include a “head end” where signals are received from satellite and other local sources, including the Internet and other services. At the head end, these signals are generally processed, modulated and combined to be transmitted via optical fibers at optical frequencies. The optical signals may be received at nodes and then converted back to RF signals. The fiber topology is generally either point-to-point or point-to-multipoint with optical cables and utility poles.

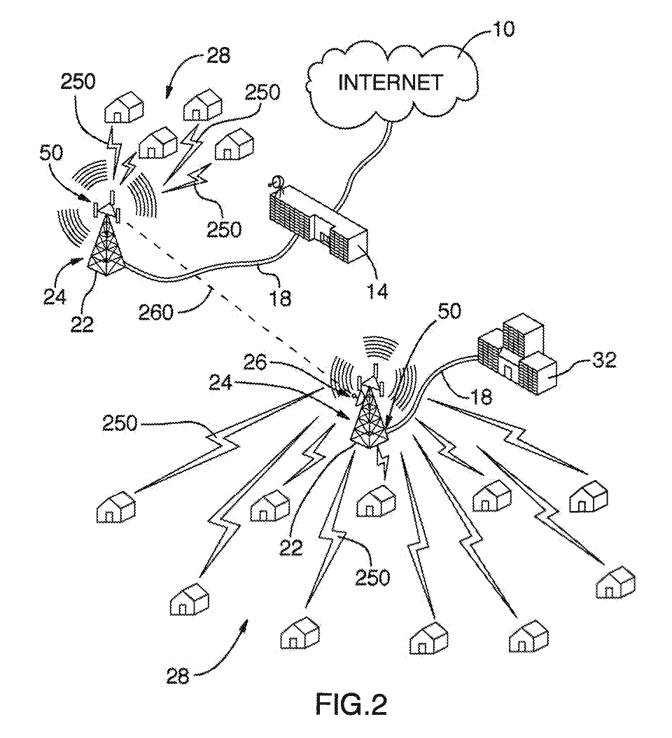

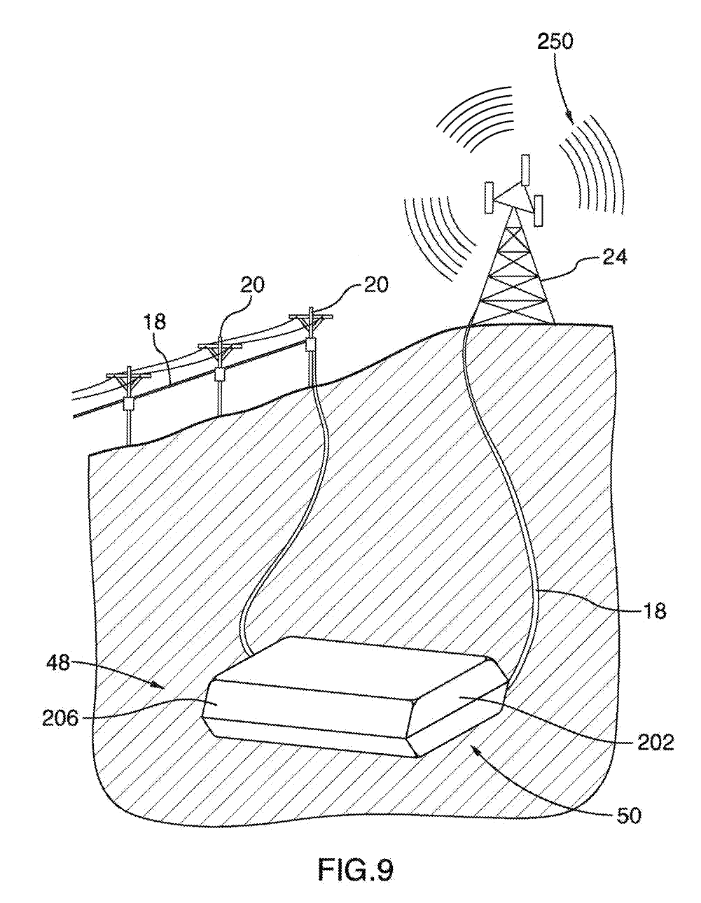

Referring now to FIG. 2 through 9 of the drawings, there is shown an apparatus 50 and method 300 for transferring signals between the fiber network 12 and a wireless network antenna 24 according to the invention. Specifically, FIG. 9 depicts an enclosure 202 of the apparatus 50 for transferring signals between the fiber network 12 and the wireless network antenna 24. The fiber network 12 includes fiber optic cables 18 and utility poles 20. The enclosure 202 may be buried underground (as shown in FIG. 9) and may preferably be provided with a rigid and substantially watertight shell 206 to protect the apparatus 50 from outside underground conditions 48.

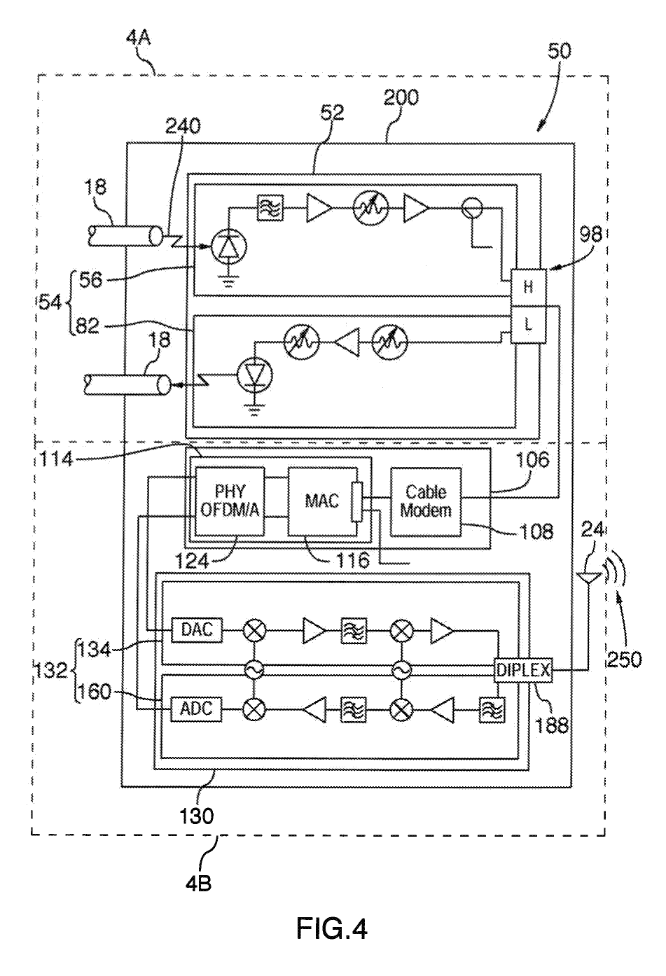

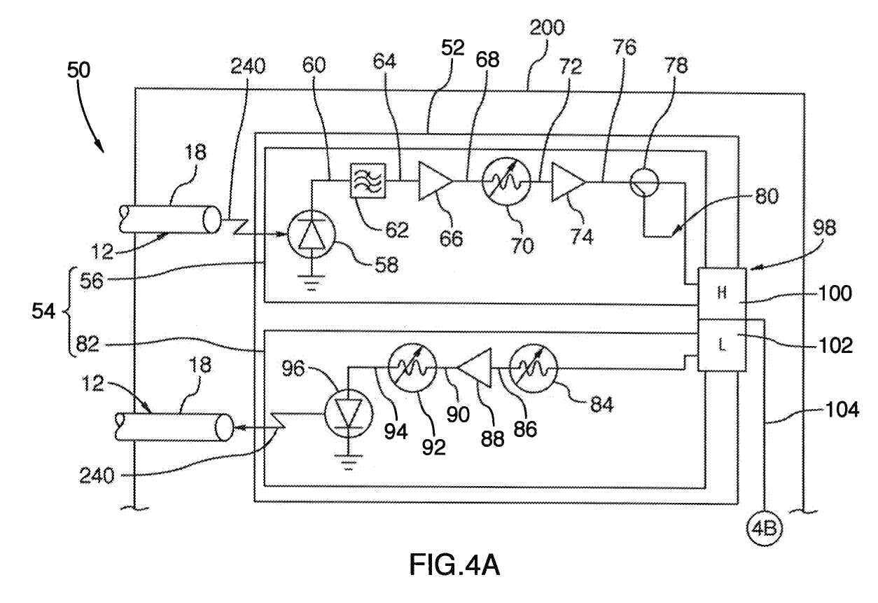

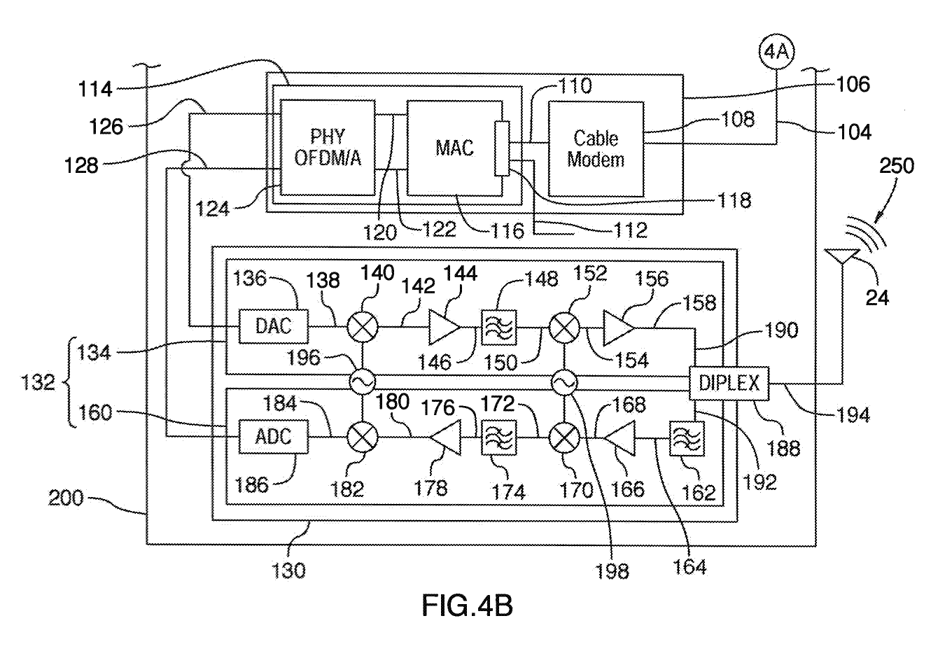

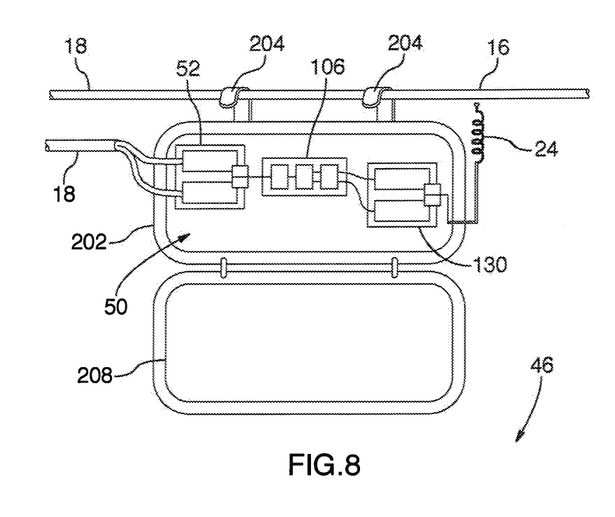

As shown in FIGS. 4 and 8, the apparatus 50 includes a fiber module 52, a WiMAX/cable modern portion 106, and at least one radio module 130. As aforesaid, and as shown in both of FIG. 8 and 9, the apparatus 50 also preferably includes the enclosure 202 (which is depicted in an open configuration in FIG. 8), with the fiber module 52, the WiMAX/cable modem portion 106, and the radio module 130 being together contained therewith in.

The enclosure 202 shown in FIG. 8 has a rugged construction that is adapted for outdoor use, such that, in a closed configuration (not shown), the enclosure 202 substantially protects internal components of the apparatus ═from outside environmental conditions 46. To this end, the enclosure 202 is also provided with an internal gasket or moisture seal 208. As shown in FIG. 8, the rugged enclosure 202 is additionally provided with suspension means 204 to suspend the apparatus 50 from a supporting member 16 such as the fiber optic cable 18. Alternately, the supporting member 16 may be one of the utility poles 20 of the fiber network 12.

As best seen in FIG. 4A, the fiber module 52 includes an RF diplexer 98 and a fiber module conversion means 54. The RF diplexer 98 preferably has a high frequency band transmission path. 100, a low frequency band reception path 102, and a combined signal path 104. As will be described in considerably greater detail hereinbelow, the fiber module conversion means 54 provides the means to convert between fiber signals 240 and RF signals (not shown) which are in a bidirectional radio frequency format that is compatible with the DOCSIS interface standard. The fiber module conversion means 54 itself includes an RF transmitting module 56 and an RF receiving module 82.

As best seen in FIG. 4A, the RF transmitting module 56 includes an optical receiving diode 58 that is optically coupled to one of the fiber optic cables 18 of the fiber network 12, so as to enable transfer of the fiber signals 240 therefrom. Preferably, in the fiber nodule 52, the optical diode 58 converts the HFC bandwidth below 1 GHz (typically 54-870 MHz) from optical fiber signals 240 into the aforesaid RF signals. The RF transmitting module 56 preferably also includes a band pass filter 62 coupled to a diode output path 60 of the optical receiving diode 58. As shown in FIG. 4A, a first amplifier 66 is coupled to a filtered output path 64 of the band pass filter 62. Preferably, the first amplifier 66 amplifies the RF signal, and the filter 62 selects the desired RF DOCSIS channels. An attenuator 70 is coupled to a first amplified output path. 68 of the first amplifier 66, and a second amplifier 74 is coupled to an attenuated output path 72 of the attenuator 70. The attenuator 70 (preferably of the pin and plug-in variety) is adapted to control the desired signal levels, and the second amplifier 74 (i.e., a post amplifier) is preferably used to boost the gain. Perhaps notably, and as shown in FIG. 4A, the RF transmitting module 56 may also include an unequal splitter 78 substantially juxtaposed between a second amplified output path 76 of the second amplifier 74 and the RF diplexer 98. Preferably, the unequal splitter 78 provides a −20 dB test point 80 that enables testing of the RF transmitting module 56. The transmission path 100 of the RF diplexer 98 is coupled downstream of the second amplified output path 76 of the RF transmitting module 56, so as to enable the transmission of the RFP signals therefrom. Alternatively, in an existing neighborhood distribution node and/or in a retrofit application, the −20 dB test point 80 may be capable of being used as an input into the RF/packet converter 108 and/or the RF diplexer 98.

Similarly, and as also shown in FIG. 4A, the RF receiving module 82 is coupled to the reception path 102 of the RF diplexer 98. More specifically, the RF receiving module 82 preferably includes a first attenuator 84 coupled to the reception path 102 of the RF diplexer 98. An amplifier 88 is coupled to a first attenuated output path 86 of the first attenuator 84, and a second attenuator 92 is coupled to an amplified output path 90 of the amplifier 88. An optical transmitting diode 96 is preferably coupled to a second attenuated output path 94 of the second attenuator 92, so as to control the correct signal levels into the respective elements The optical transmitting diode 96 of the RF receiving module 82 is also coupled to a fiber optic cable 18 of the fiber network 12 so as to enable transfer of the fiber signals 240 thereto.

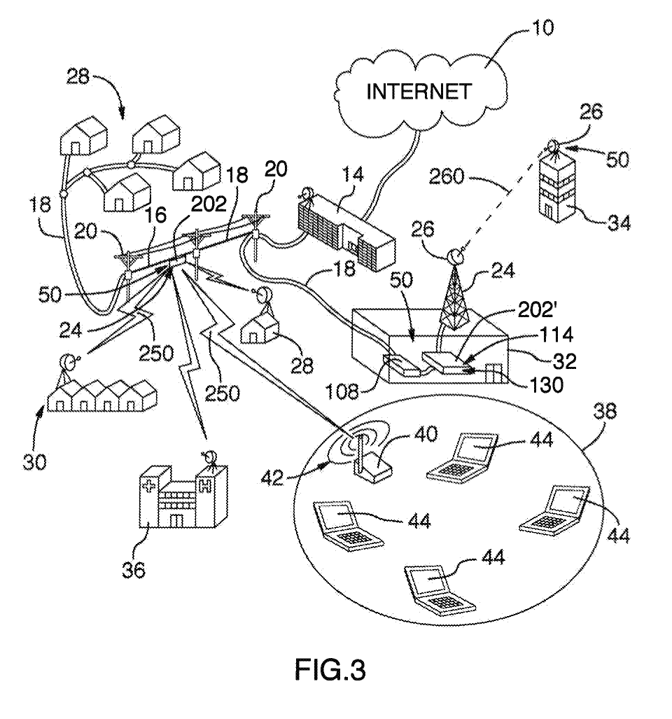

As best seen in FIG. 4B, the WiMAX/cable modem portion 106 includes an RF/packet converter 108 and a plurality of WiMAX layers 114. The terminology “WiMAX layer(s)” is used herein to denote, among other things, OSI layers that are mapped to one or more IEEE 802.16 media access control (BEC) and/or physical (PHY) layer(s). In the preferred embodiment of the apparatus 50 that is shown in FIG. 4, the RF/packet converter 108 and the WiMAX layers 114 are together formed on a single circuit board 200. More preferably, they are together integrated into a single integrated circuit (not shown) on the circuit board 200. Alternately, and as shown in FIG. 3, the WiMAX layers 114 and the radio module 130 may be together contained within a single enclosure 202′ (with the RF/packet converter 108 provided within its own separate enclosure, much the same as cable modems in the prior art)

The RF/packet converter 108 is in RF communicating relation with the combined signal path 104 of the RF diplexer 98 of the fiber module 52, so as to enable bidirectional transfer of the RF signals thereto and therefrom. The RF/packet converter 108 preferably includes a signal processor (not shown) that, as may be generally well-known in the prior art, is adapted to convert between the RF signals and data packets (not shown) which are in a packet format that is compatible with the IEEE 802.16 wireless networking standards. To this end, and as may also be generally well-known in the prior art, the signal processor of the RF/packet converter 108 includes a DOCSIS/Ethernet converter (not shown) in the aforesaid RF communicating relation with the fiber module 52. The DOCSIS/Ethernet converter preferably converts between RF signals and Ethernet signals which are in a bidirectional interface format that is compatible with the IEEE 802.3 standard. The signal processor of the RF/packet converter 108 also includes an Ethernet MAC processor (not shown) in Ethernet communicating relation with the DOCSIS/Ethernet converter, so as to enable operative bidirectional transfer of the Ethernet signals thereto and therefrom, and so as to preferably, and as may be generally well-known in the prior art, convert between the Ethernet signals and data packets in the aforesaid packet format.

The WiMAX layers 114 include a WiMAX media access control layer 116 and a baseband physical layer 124. In one preferred embodiment of the invention, as shown in FIG. 4, the WiMAX media access control layer 116 and the baseband physical layer 124 may be together integrated into the single integrated circuit (not shown) which is formed on the single circuit board 200.

The WiMAX media access control (MAC) layer 116 is in packet communicating relation with the RF/packet converter 108 so as to enable transfer of the data packets here and therefrom. The WiMAX media access control layer 116 includes at least one WiMAX MAC processor (not shown,) The WiMAX MAC processor which is adapted to bidirectionally convert between the data packets and bit stream signals (not shown) which are in a bit stream format that is compatible with the IEEE 802.16 wireless networking standard

The baseband physical layer 124 is in bit stream communicating relation with the WiMAX media access control layer 116, by way of bitstream transmission and reception paths 120, 122, so as to enable operative transfer of the bit stream signals thereto and, therefrom The baseband physical layer 124 includes a PHY processor not shown) The PHY processor is adapted to bidirectionally convert between the bit stream signals and baseband digital signals (not shown) which are in a baseband digital format that is compatible with the IEEE 802.16 wireless networking standard.

As is also best seen in FIG. 4B, the radio module 130 includes an antenna diplexer/switch 188 and a radio module conversion means 132. The antenna diplexer/switch 188 preferably includes a transmission path 190, a reception path 192, and a combined signal path 194 which is preferably coupled to the wireless network antenna 24. As will be appreciated by those skilled in the art, the antenna diplexer/switch 188 may utilize frequency division duplexing (FDD) and/or time division duplexing (TDD).

The radio module conversion means 132 provides the means to convert between the aforesaid baseband digital signals and analog signals 250 which are in an analog format that is compatible with the IEEE 802.16 wireless networking standard. The radio module conversion means 132 includes a radio transmitting module 134 and a radio receiving module 160. It is contemplated that the entire radio module 130 or one or more o the radio transmitting module 134 and the radio receiving module 160 may be embodied either in a conventional radio or in a software defined radio or SDR (not shown).

The radio transmitting module 134 is coupled to the baseband physical layer 124 in baseband digital communicating relation, by way of digital transmission and reception paths 126, 128, so as to enable transfer of the baseband digital signals therefrom. More specifically, a digital to analog converter 136 of the radio transmitting module 134 is coupled to the baseband physical layer 124 by the digital transmission path 128 in the aforesaid baseband digital communicating relation. Preferably, and as shown in FIG. 4B, a first oscillating signal mixer 140 is coupled to a converted output path 138 of the digital to analog converter 136, and a first amplifier 144 is coupled to a first mixed output path 142 of the first oscillating signal mixer 140. A band pass filter 148 is coupled to a first amplified output path 146 of the first amplifier 144, and a second oscillating signal mixer 152 is coupled to a filtered output path 150 of the band pass filter 148. A power amplifier 156 is coupled to a second mixed output path 154 of the second oscillating signal mixer 152. Preferably, and as shown in FIG. 4B, a power amplified output path 158 of the power amplifier 156 is coupled to the transmission path 190 of the antenna diplexer/switch 188, so as to enable the radio transmitting module 134 to transfer the analog signals 250, along the combined signal path 194 of the antenna diplexer/switch 188, to the wireless network antenna 24.

Similarly, and as also shown in FIG. 4B, the radio receiving module 160 is preferably coupled to the reception path 192 of the antenna diplexer/switch 188, so as to enable transfer of the analog signals 250 from the wire less network antenna 24. More specifically, a first band pass filter 162 of the radio receiving module 160 is preferably coupled to the reception path 192 of the antenna diplexer/switch 188. Preferably, a low noise amplifier 166 is coupled to a first filtered output path 164 of the first band pass filter 162, and a first oscillating signal mixer 170 is coupled to a low noise amplified output path 168 of the low noise amplifier 166. A second band pass filter 174 is preferably coupled to a first mixed output path 172 of the first oscillating signal mixer 170, and a second amplifier 178 may be preferably coupled to a second filtered output path 176 of the second band pass filter 174. As shown in FIG. 4B, a second oscillating signal mixer 182 may be coupled to a second amplified output path 180 of the second amplifier 178, and an analog to digital converter 1836 may be coupled to a second mixed output path 184 of the second oscillating signal mixer 182. The analog to digital converter 186 is preferably coupled to the baseband physical layer 124 in the aforesaid baseband digital communicating relation, by way of the digital reception path 128, so as to enable the radio receiving module 160 to transfer the baseband digital signals to the baseband physical layer 124.

As shown in FIG. 4B, first and second oscillating signal sources 196, 198 may be used by the oscillating signal mixers 140, 152, 170, 182 of the radio module 130 during the conversion between the analog signals 250 and the baseband digital signals (not shown).

In use, the apparatus 50 operatively transfers signals between the fiber network 12 and the wireless network antenna 24 both in a fiber to wireless stage and in a wireless to fiber stage, each of which stages is hereinafter described, in turn, with reference to FIGS. 4A and 4B.

In the fiber to wireless stage, and as will be appreciated from FIG. 4A, the RF transmitting module 56 of the fiber module 52 is adapted to transfer the fiber signals 240 from the fiber network 12. The fiber module conversion means 54 then converts the fiber signals 240 into the aforesaid RF signals. More specifically, the RF transmitting module 56 converts the fiber signals 240 into RF signals, and transmits the RF signals to the transmission path 100 of the RF diplexer 98. That is, the fiber module 52 outputs RF signals (in the desired DOCSIS format) which enter the high frequency band transmission path 100 (or high end) of the RF diplexer 98. Thereafter, the RF diplexer 98 transmits the RF signals along the combined signal path 104. That is, and as will be best appreciated from FIGS. 4A and 4B, in the fiber to wireless stage, the RF diplexer 98 outputs the RF signals to the RF/packet converter 108 (alternately hereinafter referred to as the cable modem block) of the WiMAX/cable modem portion 106 of the apparatus 50.

As aforesaid and as will be appreciated from FIG. 4B, in the fiber to wireless stage, the RF/packet converter 108 transfers the RF signals from the combined signal path 104. The signal processor of the cable modem block 108 converts the RF signals into the aforesaid data packets. More specifically, the DOCSIS/Ethernet converter (not shown converts the RF signals into the aforesaid Ethernet signals (802.3). Preferably, the DOCSIS/Ethernet converter may be adapted to support DOCSIS 1.0, 1.1, 2.0, 3.0 and future versions thereof. It will, therefore, be appreciated that the output of the cable modem block 108 conforms to Ethernet 802.3 standard protocols. Thereafter, the Ethernet MAC processor (not shown) of the cable modem block 108 transfers the Ethernet signals from the DOCSIS/Ethernet converter and converts them into the aforesaid data packets.

The data packets outputted by the cable modem block 108 are fed into the WiMAX media access control layer 116, which is preferably adaptable to support the IEEE 802.16 wireless networking standard in all of its variations (including the IEEE 802.16-2004 and d IEEE 802.16 TGe standards, and future versions thereof). Other formats, including ATM and Ethernet packets, might also be multiplexed into the WiMAX media access control layer 116 through a MAC multiplexer 118 (shown in FIG. 4B), so as to optimize a total throughput rate or as high as 70 Mbps. The WiMAX media access control layer 116 transfers the data packets from the Ethernet MAC processor of the cable modem block 108, and the WiMAX MAC processor (not shown) converts them into the aforesaid bit stream signals. More specifically, the WiMAX media access control layer 116 preferably outputs the bitstream signals as IEEE 802.16 protocol data units (PDUs) to the baseband physical layer 124 (alternately hereinafter referred to as the WiMAX PHY layer).

The WiMAX PHY layer 124 then transfers the bit stream signals from the WiMAX media access control layer 116, and the PHY processor (not shown, converts them into the aforesaid baseband digital signals. The PHY processor of the WiMAX PHY Layer 124 preferably also employs orthogonal frequency division multiplexing (OFDM) of the above specifications. The output of the PHY processor, in the form of the baseband digital signals, is transferred to the radio module 130.

In the next part of the fiber to wireless stage, and as will be appreciated from FIG. 4B, the radio transmitting module 134 of the radio module 130 transfers the baseband digital signals from the baseband physical layer 124. The radio transmitting module 134 then converts the baseband digital signals into the analog signals 250, and transfers the analog signals 250 to the wireless network antenna 24 for transmission according to the IEEE 802.16 wireless networking standard. More specifically, and whether the radio model 130 is a conventional radio or a software defined radio, the digital to analog converter 136 (DAC) of the radio transmitting module 134 converts the baseband digital signals into the analog signals 250. These analog signals are amplified and filtered, preferably in two stages. Preferably, one or more of the first amplifier 144 and the power amplifier 156 is a low noise amplifier (LNA) that amplifies the analog signal 250 into the desired frequencies in the microwave range. Currently, there is WiMAX support for frequencies in the 2.5 GHz and 5.8 GHz license exempt bands and in the 3.5 GHz licensed band in most countries. According to the invention, future licensed and license exempt bands are preferably capable of being included through a hardware implementation and/or through the SDR implementation of the radio module 130 which is discussed above. Preferably, the power amplified output path 158 of the radio transmitting module 134 is operatively connected to the wireless network antenna 24 that is preferably adapted to transmit the microwave analog signals 250 in a point to multipoint environment, such as that shown in each of FIGS. 2 and 3.

Turning now to the wireless to fiber stage, and as will be appreciated front FIG. 4B, the analog signals 250 according to the IEEE 802.16 wireless networking standard are received by the wireless network antenna 24, and transferred to the radio receiving module 160 of the radio module 130. Generally speaking, the radio receiving module 160 converts the analog signals 250 into the aforesaid baseband digital signals, and transfers the baseband digital signals to the baseband physical layer 124. More specifically, received analog signals 250 travel from the wireless network antenna 24 and enter the band pass filters 162, 174 for the selection of desired bands, preferably in two subs-tages, with the selected desired bands being respectively amplified at each of the sub-stages by the amplifiers 166, 178 (one or more of which may be power amplifiers) These selectively amplified analog signals 250 then enter the analog to digital converter 186 (ADC) which outputs the aforesaid baseband digital signals.

Thereafter, and as will be appreciated from FIG. 4B, the baseband digital signals enter the baseband physical layer 124 and, from there, the WiMAX media access control layer 116. More specifically, the PHY processor (not shown) of the baseband physical layer 124 converts the baseband digital signals into the aforesaid bit stream signals, and the baseband physical layer 124 transfers the bit stream signals to the WiMAX media access control layer 116. In the WiMAX media access control layer 116, the WiMAX MAC processor (not shown) converts the bit stream signals into the aforesaid data packets. Thereafter, the WiMAX media access control layer 116 transfers the data packets to the cable modem block 108, where the signal processor (not shown) converts them into the aforesaid RF signals. More specifically, the Ethernet MAC processor (not shown converts the data packets into the aforesaid Ethernet signals, and then transfers the Ethernet signals to the DOCSIS/Ethernet converter (not shown). The DOCSIS/Ethernet converter then converts the Ethernet signals into the aforesaid RF signals, and preferably transfers the RF signals In the low frequency band, as will be appreciated from FIG. 4A, to the combined signal path 104 (which may be an RF coaxial cable of the RF diplexer 98.

In the next part of the wireless to fiber stage, and as will be appreciated from FIG. 4A, the RF diplexer transmits 98 the RF signals along the reception path 102 to the RF receiving module 82. The reception path 102 of the RF diplexer 98 is preferably the lower end thereof which typically outputs weak RF signals. These weak RF signals are preferably amplified and attenuated for desired levels within the RF receiving module 82, before passing into the optical transmitting diode 96 (preferably an optical laser diode) that optically converts the RF signals into the fiber signals 240. These fiber signals 240 are then transferred to enter the return path of the fiber network 12 (or HFC system).

method 300 for transferring signals between the fiber network 12 and the wireless network antenna 24 according to the present invention will now be briefly described with reference to the figures. It will be appreciated by one skilled in the art that the method 300 outlined hereinbelow is but one such method that falls within the scope of the invention as circumscribed by the appended claims. In the following description, the same reference numerals have been used to indicate various components, relations, and configurations which are common to both the method 300 and the apparatus 50 (described above) of the present invention. It should, however, be appreciated that, although some of the components, relations, and configurations of the apparatus 50 are not specifically referenced in the following description of the method 300, they may be used, and/or adapted for use, in association therewith.

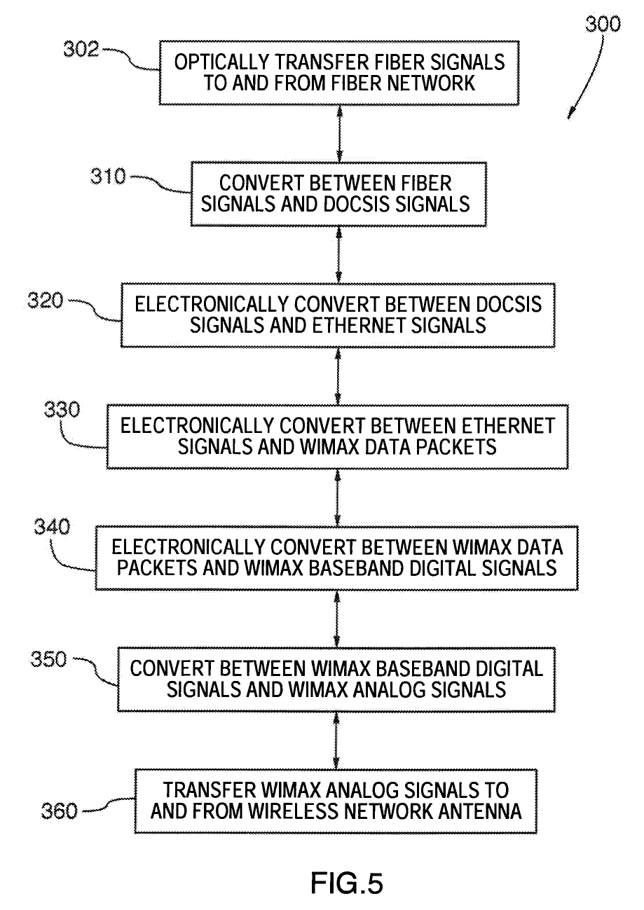

Now, therefore, as shown in FIG. 5, the method 300 includes a step 302 of optically transferring fiber signals 240 to and from the fiber network 12. Preferably, in step 302, the optical diodes 58, 96 (shown in FIG. 4A) optically transfer the fiber signals 240 to and from three fiber network 12. Preferably, before step 302, the optical diodes 58 96 are optically coupled to the fiber optic cables 18, 18 of the fiber network 12, and the enclosure 202 is suspended from the supporting member 16 (shown in FIG. 8).

As shown in FIG. 5, the method 300 also Includes a step 310 of converting between the fiber signals 240 and RF signals which are in a bidirectional radio frequency format that is compatible with the DOCSIS interface standard. In association with step 310, and as shown in FIG. 4A and 4B, the RF diplexer 98 bidirectionally transfers the RF signals over the combined signal path 104 to and from the cable modem block 108 according to the DOCSIS interface standard. The method 300 additionally includes a step 320 of electronically converting between the aforesaid RF signals and Ethernet signals which are in a bidirectional interface format that is compatible with the IEEE 802.3 standard. Further still, the method 300 includes a step 330 of electronically converting between the Ethernet signals and data packets which are in a packet format that is compatible with the IEEE 802.16 wireless networking standard. Preferably, therefore, in steps 320 and 330, the RF/packet converter 108 (shown in FIG. 4B) electronically converts between the RF signals and the data packets.

The method 300 additionally includes a step 340) of electronically converting between the data packets and baseband digital signals which are in a baseband digital format that is compatible with the IEEE 802.16 wireless networking standard. Preferably, in step 340, the PHY processor of the WiMAX PHY layer 124 (shown in FIG. 4B) electronically converts between the data packets and the baseband digital signals.

The method 300 further includes a step 350 of converting between the aforesaid baseband digital signals and analog signals 250 which are in an analog format that is compatible with the IEEE 802.16 wireless networking standards. The method 300 includes a step 360 of transferring the analog signals 250 to and from the wireless network antenna 24. Preferably, in step 360, the antenna diplexer/switch 188 (shown in FIG. 4B) bidirectionally transfers the analog signals 250 over the combined signals path 194 to and from the wireless network antenna 24.

Preferably, steps 330 and 340 are together performed by the single circuit board 200 (shown in FIG. 4), and still more preferably, by a single integrated circuit on the circuit board 200. More preferably, steps 320, 330 and 340 are together performed by the single circuit board 200, and still more preferably, by a single integrated circuit on the circuit board 200.

Additionally, steps 330, 340 and 350 are preferably together performed within the enclosure 202 (shown in FIGS. 8 and 9). More preferably, steps 310, 320, 330, 340 and 350 are preferably together performed within the single rugged enclosure 202 (shown in FIGS. 8 and 9) and/or rigid watertight shell 206 (shown in FIG. 9) that is substantially isolated from environmental conditions 46, 48.

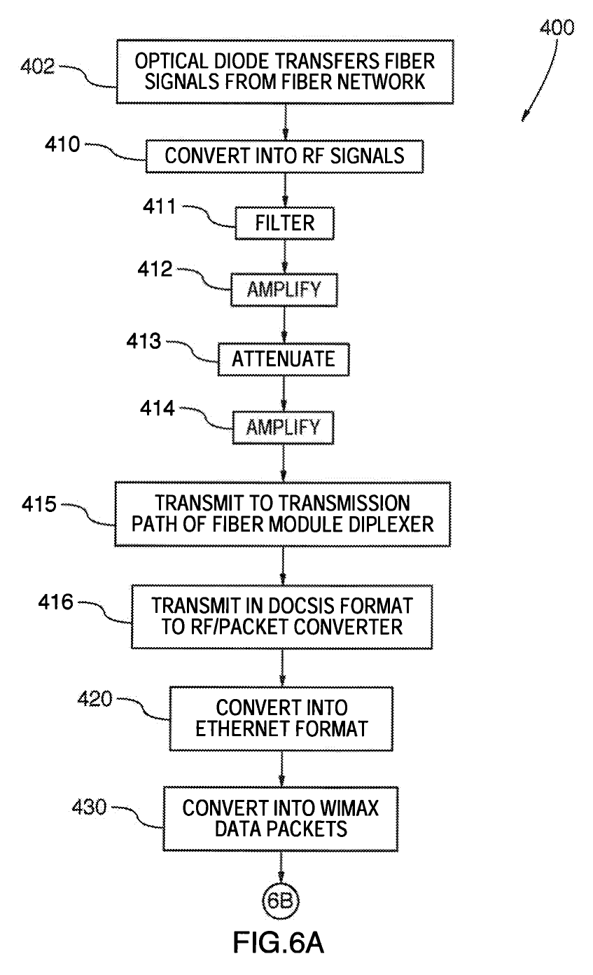

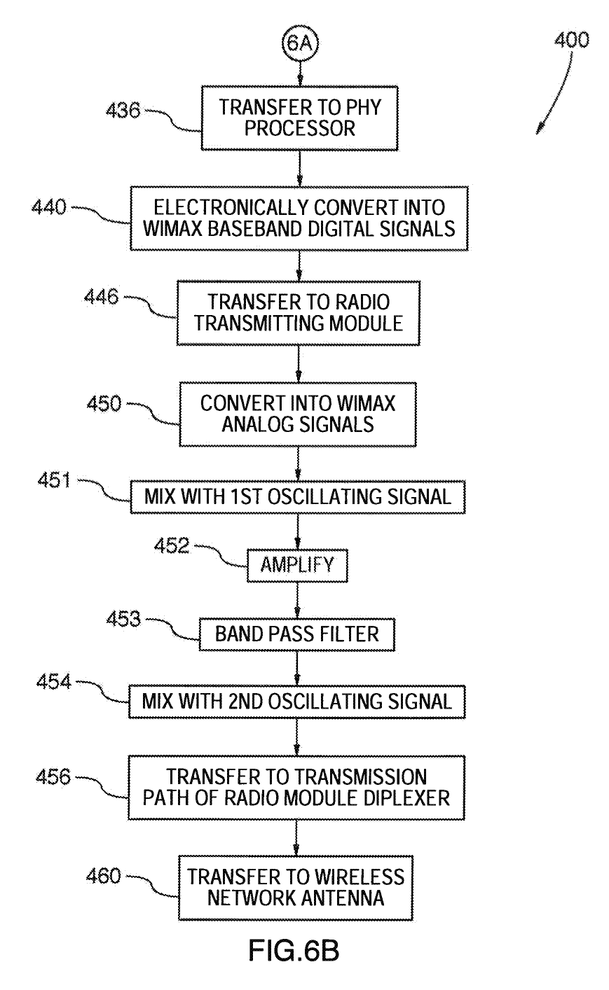

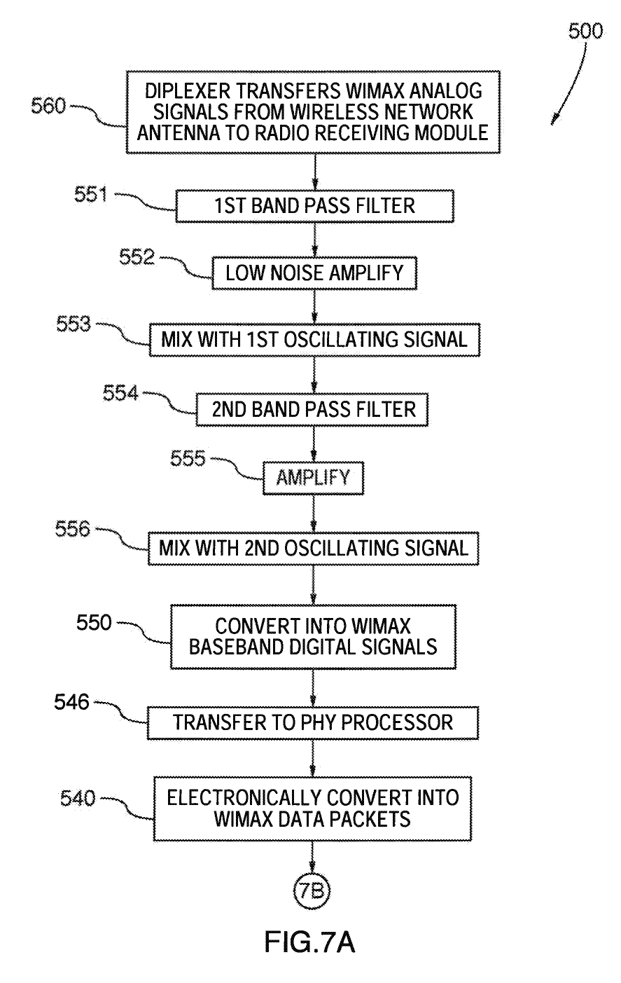

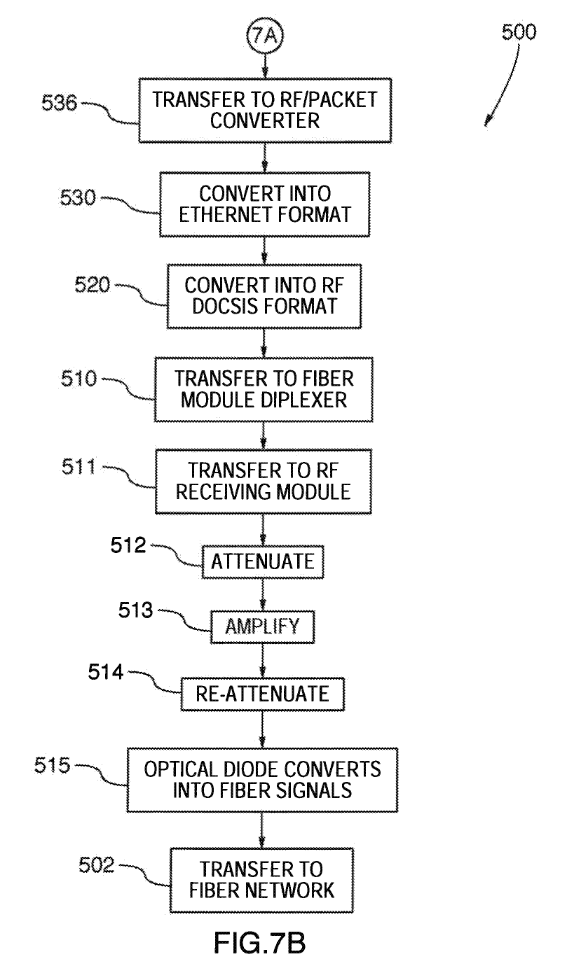

In use of the method 300 according to the invention, signal travel is operatively provided for both in the fiber to wireless stage 400 (as illustrated in some detail in FIGS. 6A and 6B) and in the wireless to fiber stage 500 (as illustrated in some detail in FIGS. 7A and 7B).

In the fiber to wireless stage 400, namely, in step 402 thereof which is show in FIG. 6A, the fiber signals 240 are optically transferred from the fiber network 12. Preferably, in step 402, the optical receiving diode 58 (shown in FIG. 4A) of the RF transmitting module 56 transfers the fiber signals 240 from the fiber network 12.

Thereafter, in step 410, the fiber signals 240 are converted into RF signals. Preferably, In step 410, the RF transmitting module 56 (shown in FIG. 4A) converts the fiber signals 240 into the RF signals. In steps 411, 412, 413 and 414, the RF signals are successively filtered, amplified, attenuated, and re-amplified within the RF transmitting module 56, before preferably being transmitted to the transmission path 100 of the RF diplexer 98 (shown in FIG. 4A). The RF transmitting module 56 is preferably coupled to the transmission path 100 of the RF diplexer 98 for transmission of the RF signals, in steps 415 and 416, to the RF/packet converter 1080.

Next, in step 420, the RF signals are converted into Ethernet signals, and in step 430, the Ethernet signals are converted into data packets. As shown in FIG. 6B, the signals are thereafter, in step 436, transferred to the PHY processor of the WiMAX PHY layer 124 (shown in FIG. 4B) and, in step 440, electronically converted into baseband digital signals.

In step 450, the baseband digital signals are converted into the analog signals 250. Preferably, in step 450, the radio transmitting module 134 (shown in FIG. 4B) receives the baseband digitally signals from the PHY processor, and converts the baseband digital signals into the analog signals 250. Thereafter, in steps 451, 452, 453 and 454, the analog signals are successively mixed with a first oscillating signal, amplified, band pass filtered, and re-mixed with a second oscillating signal, before preferably being power amplified within the radio transmitting module 134 and transferred, in step 456, to the transmission path 190 of the antenna diplexer/switch 188 (shown in FIG. 4B).

Lastly, the analog signals 250 are transferred, in step 460, to the wireless network antenna 24 (shown in FIGS. 2, 3, 4B, 8 and 9) for subsequent transmission according to the IEEE 802.16 wireless networking standard.

Now therefore, the wireless to fiber stage 500 of the method 300 is shown in some detail in FIGS. 7A and 7B. In the wireless to fiber stage 500, namely, in step 560 thereof which is shown in FIG. 7A, the analog signals 250 are preferably transferred from the wireless network antenna 24 to the combined signal path 194 of the antenna diplexer/switch 188 (shown in FIG. 4B) according to the IEEE 802.16 wireless networking standard. Thereafter, the analog signals 250 are transferred to the reception path 192 of the antenna diplexer/switch 188. Preferably, prior to step 551, the radio receiving module 160 transfers the analog signals 250 from the reception path 192 of the antenna diplexer/switch 188.

Next, in steps 551, 552, 553, 554, 555 and 556, the analog signals 250 are preferably successively filtered through the first band pass filter 162 (shown in FIG. 4B), low noise amplified, mixed with a first oscillating signal, re-filtered through the second band pass filter 174 (shown in FIG. 4B), re-amplified, and re-mixed with a second oscillating signal. Thereafter, in steps 550 and 546, the radio transmitting module 160 preferably converts the analog signals 250 into the baseband digital signals, and transfers the baseband digital signals to the PHY processor of the WiMAX PHY layer 124. Thereafter, in step 540, the baseband digital signals are electronically converted, by the PHY processor, into data packets and transferred, in step 536, to the RF/packet converter 108. The data packets are then, in step 530, converted into Ethernet signals. Thereafter, in step 520, the Ethernet signals are converted into RF signals.

Next, in step 510, the RF/packet converter 108 transfers the RF signals, preferably along the reception path 102 of the RF diplexer 98 (shown in FIG. 4A), to the RF receiving module 82 in step 511, thus beginning the process of converting the RF signals into the fiber signals 240. In steps 512, 513 and 514, the RF signals are successively attenuated, amplified, and re-attenuated within the RF receiving module 82, before finally being converted into the fiber signals 240, in step 515, and optically transferred to the fiber network 12 by the optical transmitting diode 96 in step 502.

It will be appreciated that the apparatus 50 can operate as part of an existing HFC system or as a separate entity. Cable operators are one of the likely end-users of the invention.

It will be further appreciated from the foregoing that, by way of summary, the apparatus 50 includes three main components which are seen in FIGS. 4 and 8, namely, the fiber module 52, the WiAMX/cable modem portion 106, and the radio module 130. The fiber module 52 converts the optical fiber signals 240 into radio frequency (RF) signals. The WiMAX/cable modem portion 106 changes these RF signals into the baseband digital signals, which are finally converted to microwave frequency analog signals 250 by the radio module 130. The apparatus either can be retrofitted into an existing fiber optic node of the HFC system or fiber network 12 or it can be a standalone fiber optic node of its own.

The fiber module 52 may be embodied together with the WiMAX/cable modem portion 106 and the radio module 130 (as best seen in FIG. 8), or it may take the form of an optical receiver that is present in an existing fiber optic node (not shown).

It will be further appreciated, from the foregoing and from FIG. 4, that the WiMAX/cable modem portion 106 of the apparatus 50 includes the WiMAX media access control layer 116 and the baseband physical layer 124, having respective MAC and PHY processors (not shown). The MAC and PHY processors each conform to WiMAX (IEEE 802.16) standard specifications.

FIG. 3 depicts a number of different subscriber stations, including low density home subscribers 28, high density home subscribers 30, a business subscriber 32 having a branch office 34, a government/hospital subscriber 36, as well as a WiMAX/WiFi base station 40 that converts between the WiMAX analog signals 250 and Wi-Fi signals 42 so as to service a Wi-Fi hotspot 38. It will be appreciated that the apparatus 50 may be adapted to remotely, at each of the subscriber stations 28, 30, 32, 34, 36, 40, filter and convert the received WiMAX analog signals 250 into fiber signals 240. In each case, the ADC 186 may preferably output baseband digital signals, which are then fed to the baseband physical layer 124 and the WiMAX media access control layer 116 (or WiMAX MAC layer, of the WiMAX subscriber systems 28, 30, 32, 34, 36, 40. The WiMAX MAC layer 116 of each such subscriber system 28, 30, 32, 34, 36, 40 may provide an output in an Ethernet (802.3) format. These Ethernet signals can be connected directly either to a desktop or laptop computer 44, and/or to the cable modem block 108 (shown in FIGS. 3 and 4) for retransmission. In mobile subscriber stations, the end device may be the laptop computer 44 or similar device (e.g., PDA, cell phone, mp3 player) that aids mobility.

As will be understood by a person having ordinary skill in the art, the following table provides a comparison of some of the current wireless technologies:

| | UWB | WiFi | WiMAX | 3G (WCDMA) |
|---|---|---|---|---|
| Range | <10 m | <100 m | 6-10 km | ˜12 km |
| Throughput | 100-480 Mbps | 11-54 Mbps | 70 Mbps | 2 Mbps |
| Security | Strong | Weak, WEP based | Strong 3-DES based | |
| Operations | Unlicensed | Licensed, Exempt only | Licensed and License Exempt | |
| Quality of Service (QoS) | | No QoS | UGS, rtPS, nrtPS, BE | |

Conceptually, and as best seen in FIGS. 2 and 3, the WiMAX protocol can actually provide two forms of wireless service: (i) network services conveyed by line-of-sight analog signals 260 (hereinafter alternately referred to as line-of-sight WiMAX service 260), and (ii) network services conveyed by the potentially more common non-line-of-sight analog signals 250 (hereinafter alternately referred to as non-line-of-sight WiMAX service 250). Both line-of-sight and non-line-of-sight analog signals 260, 250 are depicted in each of FIGS. 2 and 3.

In non-line-of-sight WiMAX service 250 (which is, in some respects, analogous to Wi-Fi service, a small wireless network antenna 24 (e.g., on a computer) would wirelessly connect to larger wireless network antenna 24, such as, for example, a WiMAX tower. In this mode, the WiMAX protocol may preferably use a lower frequency range—e.g., substantially in the ≦11 GHz range (i.e., similar to WiFi) lower-wavelength transmissions of this sort are generally though to be not as easily disrupted by physical obstructions. That is, these lower wavelength WiMAX transmissions are generally thought to be better able to diffract, or bend, around obstacles.

In line-of-sight WiMAX service 260, on the other hand, a fixed satellite dish antenna 26 (as shown in FIG. 3) might point straight at a WiMAX tower 24 from a rooftop or a pole. Such line-of-sight connections are generally thought to be stronger and more stable, thus generally thought to account for their at least theoretical ability to send an increased amount of data with fewer errors. Line-of-sight transmissions 260 use higher frequencies, with ranges preferably reaching at least a possible 66 GHz. Higher frequency transmissions of this sort are generally thought to be subject to less interference and have the ability to access a significantly increased amount of bandwidth.

The WiMAX (IEEE 802.16) standard defines profiles for the WiMAX MAC and PHY layers 116, 124 (which are shown in FIG. 4). It will be generally appreciated from all of the foregoing that, according to the invention, the WiMAX MAC layer 116 packs and unpacks raw data, while the PHY layer 124 handles the air-interface and modulation schemes. The WiMAX standard allows system vendors to customize their products, including the specifics of the PHY layer 124 and their amplification, filtering and transmission schemes, in order to meet specific requirements, such as, for examples, subscriber needs and radio-frequency (RF) link quality.

Frequency bands in the 2-6 GHz portion have relatively narrow allocated bandwidths. The microwave frequencies below 10 GHz are referred to as centimeter bands. Above 10 GHz, the frequency bands are known as millimeter bands. The millimeter bands have much wider allocated channel bandwidths to accommodate the larger data capacities that are generally thought to be suitable for high-data-rate, line-of-sight backhauling applications. The centimeter bands are generally thought to be best for multipoint, near-line-of-sight, tributary, and last-mile distribution.

The centimeter spectrum is generally thought to have both tributary and last-mile potential. It will be appreciated that the apparatus 50 and method 300 according to the invention may help the WiMAX standard to supplant and/or supplement DSL and cable access for last-mile service. Additionally, for spectrums below the 6 GHz range, the apparatus 50 and method 300 may help the WiMAX standard to add significant mobility and portability to applications like notebooks and PDAs.

Controlling the power levels and frequencies involved in transmission and reception is important to ensure successful communication in WiMAX networks, and these factors are generally thought to be capable of being actively managed and dynamically adjusted by the apparatus 50 and method 300 according to the invention, and depending on the profiles and distances from the base station of the end subscribers.

It will, thus be appreciated that the apparatus 50 and method 300 enable a significant extension of network services and last mile connectivity, without requiring a significant infrastructure investment or relying exclusively on coaxial cables or fiber optic cables 18, in a substantially cost effective manner. The apparatus 50 and method 300 also enable, over and above any advantages that may have previously been associated with Wi-Fi interconnectivity, fiber to WiMAX interconnectivity, and provide substantially improved broadband, secure, and mobile connectivity to end subscribers. The apparatus 50 and method 300 according to the invention provide a system that is specifically adapted to enable the use of WiMAX networks for “last mile” connectivity (i.e., from the neighborhood distribution node 22 to the end subscriber).

From the foregoing, it will also be appreciated that the apparatus 50 and method 300 according to the invention provide a system whereby WiMAX antennae 24 might be connected to a service provider's “head end” 14 via a light fiber optics cable 18. Accordingly, it will be appreciated that cable operators might utilize the apparatus 50 and method 300 according to the invention to extend services to un-serviced and under serviced areas, which may not heretofore have been easily reached. As stated hereinabove, the apparatus 50 according to the invention may be embodied in a WiMAX base station or subscriber station, The method 300 according to the invention is capable of supporting many wireless-broadband connections for home and small-business users, backhaul networks for cellular base stations, and a backhaul connections to the internet 10 for Wi-Fi hot spots 38. Using non-line-of-sight WiMAX service 260, the method 300 and apparatus 50 according to the invention might deliver services, over products like laptops 44 (as well as PDAs and cell phones), directly to the end users in a point-to-multipoint architecture.

The apparatus 50 and method 330 are also generally thought suitable to interconnect the optical fibers 18 or coaxial cables of HFC systems 12 with a fixed, mobile air interface or wireless network antenna 24 of a WiMAX network. The apparatus 50 is capable of transferring signals from HFC systems 12, DOCSIS and other similar protocols (in addition to GigE ATM to a WiMAX air interface. The apparatus 50 and method 300 according to the invention are generally thought to enable interface between DOCSIS signals and an orthogonal frequency division multiplexing (OFDM) PHY interface for broadband connectivity, The apparatus 50 and method 300 are generally thought to be suitable to enable coverage of licensed and license exempt bands and/or frequencies. These transferred WiMAX signals are generally thought to be suitable for reception by subscriber units, both fixed and mobile, and for conversion back to their original packet formats. The apparatus 50 according to the invention also follows generally the same principles when operating along a reverse pathway.

According to the invention, and as aforesaid, the apparatus 50 and method 300 might be adapted to include software defined radio elements. They support mobility and provide secure interconnectivity and transmission of data (via the IEEE 802.16e and IEEE 802.16-2004 specifications). Additionally, the apparatus 50 advantageously includes the multiplexer 118 at the base station which may preferably house the WiMAX layers 114 and which may support the DOCSIS, GigE and ATM standards. The apparatus 50 and method 300 supports very long range coverage through WiMAX implementation (and preferably in the order of at least about 10-16 kms via the IEEE 802.16e specification).

Other modifications and alterations may be used in the design and manufacture of other embodiments according to the present invention without departing from the spirit and scope of the invention, which is limited only by the accompanying claims. For example, while the system is particularly adapted for interconnecting hybrid fiber coaxial systems and WiMAX (IEEE 802.16 standard) networks, it is also adaptable for use with other fiber systems, and with other broadband wireless metropolitan access networks, Wi-Fi (IEEE 802.11 standard) networks, Bluetooth networks, home radio frequency networks, wireless home area networks, wireless campus area networks, high performance radio local area networks, other wireless local area networks, 3G networks and other WCDMA (wide-band code division multiple access) networks, ultra wide band networks, other radio frequency networks, other wireless wide area networks, and other wireless systems.

We claim:

1. An apparatus for transferring signals between a fiber network and a wireless network antenna, with the fiber network including fiber optic cables and utility poles, said apparatus comprising:
a) a fiber module adapted to be operatively coupled to the fiber network so as to enable transfer of fiber signals to and from the fiber network, with said fiber module comprising a fiber module conversion means for converting between said fiber signals and RF signals in a bidirectional radio frequency format compatible with the DOCSIS interface standard;
b) a RF/packet converter in RF communicating relation with said fiber module so as to enable bidirectional transfer of said RF signals to and from said fiber module, with said RF/packet converter comprising at least one signal processor adapted to convert between said RF signals and data packets in a packet format compatible with the IEEE 802.16 wireless networking standard;
c) a WIMAX media access control layer in packet communicating relation with said RF/packet converter so as to enable transfer of said data packets to and from said RF/packet converter, with said media access control layer comprising at least one WIMAX MAC processor adapted to bidirectionally convert between said data packets and bit stream signals in a bit stream format compatible with the IEEE 802.16 wireless networking standard;
d) a baseband physical layer in bit stream communicating relation with said media access control layer so as to enable operative transfer of said bit stream signals to and from said media access control layer, with said baseband physical layer comprising a PHY processor adapted to bidirectionally convert between said bit stream signals and baseband digital signals in a baseband digital format compatible with the IEEE 802.16 wireless networking standard; and
e) a radio module in baseband digital communicating relation with said baseband physical layer so as to enable transfer of said baseband digital signals to and from said baseband physical layer, with said radio module comprising a radio module conversion means for converting between said baseband digital signals and analog signals in an analog format compatible with the IEEE 802.16 wireless networking standard, with said radio module adapted to be operatively coupled to the wireless network antenna so as to enable transfer of said analog signals to and from the wireless network antenna;
wherein said apparatus operatively transfers signals between the fiber network and the wireless network antenna in a fiber to wireless stage and in a wireless to fiber stage;
wherein, in the fiber to wireless stage, said fiber module transfers said fiber signals from the fiber network, said fiber module conversion means converts said fiber signals into said RF signals, said RF/packet converter transfers said RF signals from said fiber module, said at least one signal processor converts said RF signals into said data packets, said WIMAX media access control layer transfers said data packets from said RF/packet converter, said at least one WIMAX MAC processor converts said data packets into said bit stream signals, said baseband physical layer transfers said bit stream signals from said media access control layer, said PHY processor converts said bit stream signals into said baseband digital signals, said radio module transfers said baseband digital signals from said baseband physical layer, said radio module conversion means converts said baseband digital signals into said analog signals, and said radio module transfers said analog signals to the wireless network antenna for transmission according to the IEEE 802.16 wireless networking standard; and
wherein, in the wireless to fiber stage, said radio module transfers said analog signals from the wireless network antenna according to the IEEE 802.16 wireless networking standard, said radio module conversion means converts said analog signals into said baseband digital signals, said radio module transfers said baseband digital signals to said baseband physical layer, said PHY processor converts said baseband digital signals into said bit stream signals and said baseband physical layer transfers said bit stream signals to said WIMAX media access control layers said at least one WIMAX MAC processor converts said bit stream signals into said data packets and said WIMAX media access control layer transfers said data packets to said RF/packet converter, said at least one signal processor converts said data packets into said RF signals, said RF/packet converter transfers said RF signals to said fiber module, said fiber module conversion means converts said RF signals into said fiber signals, and said fiber module transfers said fiber signals to the fiber network.

2. An apparatus according to claim 1, wherein said at least one signal processor of said RF/packet converter comprises:
a) a DOCSIS/Ethernet converter in said RF communicating relation with said fiber module, with said DOCSIS/Ethernet converter adapted to convert between said RF signals and Ethernet signals in a bidirectional interface format compatible with the IEEE 802.3 standard; and
b) an Ethernet MAC processor in Ethernet communicating relation with said DOCSIS/Ethernet converter so as to enable operative bidirectional transfer of said Ethernet signals to and from said DOCSIS/Ethernet converter, with said Ethernet MAC processor adapted to convert between said Ethernet signals and said data packets in said packet format;
wherein, in the fiber to wireless stage, said DOCSIS/Ethernet converter transfers said RF signals from said fiber module and converts said RF signals into said Ethernet signals, said Ethernet MAC processor transfers said Ethernet signals from said DOCSIS/Ethernet converter and converts said Ethernet signals into said data packets, and said WiMAX media access control layer transfers said data packets from said Etherntet MAC processor; and
wherein, in the wireless to fiber stage, said WIMAX media access control layer transfers said data packets to said Ethernet MAC processor, said Ethernet MAC processor converts said data packets into said Ethernet signals and transfers said Ethernet signals to said DOCSIS/Ethernet converter, and said DOCSIS/Ethernet converter converts said Ethernet signals into said RF signals and transfers said RF signals to said fiber modules.

3. An apparatus according to claim 2, wherein said RF/packet converter, said WIMAX media access control layer, and said baseband physical layer are together formed on a single circuit board.

4. An apparatus according to claim 3, wherein said RF/packet converter, WIMAX media access control layer, and said baseband physical layer are together integrated into a single integrated circuit on said circuit board.

5. An apparatus according to claim 3, further comprising an enclosure, with said fiber module, said RF/packet converter, said WIMAX media access control layer, said baseband physical layer, and said radio module being together contained within said enclosure.

6. An apparatus according to claim 5, wherein said enclosure is a rugged enclosure adapted for outdoor use so as to substantially protect said fiber module, said RF/packet converter, said WIMAX media access control layer, said baseband physical layer, and said radio module from outside environmental conditions.

7. An apparatus according to claim 6, wherein said fiber module is further adapted to be operatively coupled to at least one of the fiber optic cables of the fiber network, and wherein said rugged enclosure is provided with suspension means for suspending said enclosure from a supporting member selected from said utility poles and said fiber optic cables.

8. An apparatus according to claim 5, wherein said enclosure is a rugged enclosure having a rigid watertight shell so as to substantially protect said fiber module, said RF/packet converter, said WIMAX media access control layer, said baseband physical layer, and said radio module from outside underground conditions.

9. An apparatus according to claim 2, wherein said WIMAX media access control layer and said baseband physical layer are together formed on a single circuit board.

10. An apparatus according to claim 9, wherein said WIMAX media access control layer and said baseband physical layer are together integrated into a single integrated circuit on said circuit board.

11. An apparatus according to claim 9, further comprising an enclosure, with said WIMAX media access control layer, said baseband physical layer, and said radio module being together contained within said enclosure.

12. An apparatus according to claim 1, wherein said fiber module further comprises a RF diplexer having a transmission path, a reception path, and a combined signal path in said RF communicating relation with said RF/packet converter, and wherein said fiber module conversion means comprises,
a) a RF transmitting module coupled to said transmission path of said RF diplexer, with said RF transmitting module being adapted to be operatively coupled to the fiber network, wherein in, said fiber to wireless stage, said RF transmitting module transfers said fiber signals from the fiber network, converts said fiber signals into said RF signals, and transmits said RF signals to said transmission path of said RF diplexer, with said RF diplexer transmitting said RF signals along said combined signal path to said RF/packet converter; and
b) a RF receiving module coupled to said reception path of said RF diplexer, with said RF receiving module being adapted to be operatively coupled to the fiber network, wherein in said wireless to fiber stage, said RF/packet converter transmits said RF signals to said combined signal path of said RF diplexer, said RF diplexer transmits said RF signals along said reception path to said RF receiving module, said RF receiving module converts said RF signals into said fiber signals, and transfers said fiber signals to the fiber network.

13. An apparatus according to claim 12, wherein said transmission path of said RF diplexer comprises a high frequency band transmission path, and said reception path comprises a low frequency band reception path.

14. An apparatus according to claim 12, wherein said RF transmitting module comprises an optical receiving diode adapted to be optically coupled, to the fiber network so as to enable said transfer of said fiber signals from the fiber network in said fiber to wireless stage.

15. An apparatus according to claim 14, wherein said RF transmitting module further comprises a band pass filter coupled to a diode output path of said optical receiving diode, a first amplifier coupled to a filtered output path of said band pass filter, an attenuator coupled to a first amplified output path of said first amplifier, and a second amplifier coupled to an attenuated output path of said attenuator, with said transmission path of said RF diplexer coupled to a second amplified output path of said second amplifier so as to enable said transmission of said RF signals from said RF transmitting module to said RF/packet converter in said fiber to wireless stage.

16. An apparatus according to claim 15, wherein said RF transmitting module further comprises an unequal splitter in substantially juxtaposed relation between said RF diplexer and said second amplified output path of said second amplifier, with said unequal splitter providing a test point so as to enable testing of said RF transmitting module.

17. An apparatus according to claim 12, wherein said RF receiving module comprises an optical transmitting diode adapted to be optically coupled to the fiber network so as to enable said transfer of said fiber signals to the fiber network in said wireless to fiber stage.

18. An apparatus according to claim 17, wherein said RF receiving module further comprises a first attenuator coupled to said reception path of said RF diplexer so as to enable said reception by said RF receiving module of said RF signals from said RF/packet converter in said wireless to fiber stage, an amplifier coupled to a first attenuated output path of said first attenuator, and a second attenuator coupled to an amplified output path of said amplifier, with said optical transmitting diode coupled to a second attenuated output path of said second attenuator.

19. An apparatus according to claim 1, wherein said radio module conversion means comprises:
a) a radio transmitting module coupled to said baseband physical layer in said baseband digital communicating relation, with said radio transmitting module being adapted to be operatively coupled to the wireless network antenna, wherein in the fiber to wireless stage, said radio transmitting module transfers said baseband digital signals from said baseband physical layer, converts said baseband digital signals into said analog signals, and transfers said analog signals to the wireless network antenna; and
b) a radio receiving module coupled to said baseband physical layer in said baseband digital communicating relation, with said radio receiving module being adapted to be operatively coupled to the wireless network antenna, wherein in said wireless to fiber stage, said radio receiving module transfers said analog signals from the wireless network antenna, converts said analog signals into said baseband digital signals, and transfers said baseband digital signals to said baseband physical layer.

20. An apparatus according to claim 19, wherein at least one of said radio transmitting module and said radio receiving module is embodied in a software defined radio.

21. An apparatus according to claim 20, wherein both of said radio transmitting module and said radio receiving module are embodied in said software defined radio.

22. An apparatus according to claim 19, wherein said radio module further comprises an antenna diplexer/switch having a transmission path, a reception path, and a combined signal path adapted to be operatively coupled to the wireless network antenna, with said radio transmitting module coupled to said transmission path of said antenna diplexer/switch for operative transfer of said analog signals to the wireless network antenna in said fiber to wireless stage, and with said radio receiving module coupled to said reception path of said antenna diplexer/switch for transfer of said analog signals from the wireless network antenna in said wireless to fiber stage.

23. An apparatus according to claim 22, wherein said radio transmitting module comprises a digital to analog converter coupled to said baseband physical layer in said baseband digital communicating relations a first oscillating signal mixer coupled to a converted output path of said digital to analog converter, a first amplifier coupled to a first mixed output path of said first oscillating signal mixer, a band pass filter coupled to a first amplified output path of said first amplifier, a second oscillating mixer coupled to a filtered output path of said band pass filter, and a power amplifier coupled to a second mixed output path of said second oscillating mixer, with said transmission path of said antenna diplexer/switch coupled to a power amplified output path of said power amplifier so as to enable said transfer of said analog signals to the wireless network antenna in said fiber to wireless stage.

24. An apparatus according to claim 22, wherein said radio receiving module comprises a first band pass filter coupled to said reception path of said antenna diplexer/switch so as to enable said transfer of said analog signals from the wireless network antenna, a low noise amplifier coupled to a first filtered output path of said first band pass filter, a first oscillating mixer coupled to a low noise amplified output path of said low noise amplifier, a second band pass filter coupled to a first mixed output path of said first oscillating mixer, a second amplifier coupled to a second filtered output path of said second band pass filter, a second oscillating mixer coupled to a second amplified output path of said second amplifier, and an analog to digital converter coupled to a second mixed output path of said second oscillating mixer, with said analog to digital converter coupled to said baseband physical layer in said baseband digital communicating relation so as to enable said transfer of said baseband digital signals to said baseband physical layer in said wireless to fiber stage.

25. A method of transferring signals between a fiber network and a wireless network antenna, said method comprising the steps of:
a) optically transferring fiber signals to and from the fiber network;
b) converting between said fiber signals and RF signals in a bidirectional radio frequency format compatible with the DOCSIS interface standard;
c) electronically converting between said RF signals and data packets in a packet format compatible with the IEEE 802.16 wireless networking standard;
d) electronically converting between said data packets and baseband digital signals in a baseband digital format compatible with the IEEE 802.16 wireless networking standard;
e) converting between said baseband digital signals and analog signals in an analog format compatible with the IEEE 802.16 wireless networking standard; and
f) transferring said analog signals to and from the wireless network antenna;
wherein, in an operative fiber to wireless stage, said fiber signals are optically transferred from the fiber network, said fiber signals are converted into said RF signals, said RF signals are electronically converted into said data packets, said data packets are electronically converted into said baseband digital signals, said baseband digital signals are converted into said analog signals, and said analog signals are transferred to the wireless network antenna for transmission according to the IEEE 802.16 wireless networking standard; and
wherein, in an operative wireless to fiber stage, said analog signals are transferred from the wireless network antenna according to the IEEE 802.16 wireless networking standard, said analog signals are converted into said baseband digital signals, said baseband digital signals are electronically converted into said data packets, said data packets are electronically converted into said RF signals, said RF signals are converted into said fiber signals, and said fiber signals are optically transferred to the fiber networked.

26. A method according to claim 25, wherein step (c) comprises the steps of:
c.1) electronically converting between said RF signals and Ethernet signals in a bidirectional interface format compatible with the IEEE 802.3 standard; and c.2) electronically converting between said Ethernet signals and said data packets in said packet format;
such that, in said, operative fiber to wireless stage, said RF signals are converted into said Ethernet signals, and said Ethernet signals are converted into said data packets, before said data packets are electronically converted into said baseband digital signals; and
such that, in said operative wireless to fiber stage, said data packets are converted into said Ethernet signals, and said Ethernet signals are converted into said RF signals, before said RF signals are converted into said fiber signals.

27. A method according to claim 26, wherein steps (c) and (d) are together performed by a single circuit board.

28. A method according to claim 27, wherein stems (c) and (d) are together performed by a single integrated circuit on said circuit board.

29. A method according to claim 27, wherein steps (b), (c), (d) and (e) are together performed within a single rugged enclosure that is substantially isolated from environmental conditions.

30. A method according to claim 29, wherein, in step (a), optical diodes optically transfer said fiber signals to and from the fiber network, and wherein, before step (a), said method comprises additional steps of:
i) optically coupling said optical diodes to at least one fiber optic cable of the fiber network; and
ii) suspending said enclosure from at least one supporting member selected from the group consisting of a utility pole and said at least one fiber optic cable.

31. A method according to claim 27, wherein steps (b), (c), (d) and (e) are together performed within a rigid watertight enclosing shell of a single rugged enclosure.

32. A method according to claim 26, wherein steps (c.2) and (d) are together performed by a single circuit board.

33. A method according to claim 32, wherein steps (c.2) and (d) are together performed by a single integrated circuit on said circuit board.

34. A method according to claim 32, wherein steps (c.2), (d), and (e) are together performed within a single enclosure.

35. A method according to claim 25, wherein, in step (c), a RF/packet converter electronically converts between said RF signals and said data packets; wherein in step (b), a RF diplexer having a transmission path, a reception path, and a combined signal path bidirectionally transfers said RF signals over said combined signal path to and from said RF/packet converter according to the DOCSIS interface standard.

36. An apparatus according to claim 25, wherein, in step (c), a RF/packet converter electronically converts between said RF signals and said data packets; wherein, in step (b), a RF diplexer having a high frequency band transmission path, a low frequency band reception path, and a combined signal path bidirectionally transfers said RF signals over said combined signal path to and from said RF/packet converter according to the DOCSIS interface standard.

37. A method according to claim 35, wherein, in step (a), a RF transmitting module transfers said fiber signals from the fiber network in said fiber to wireless stage; wherein, in step (b), said RF transmitting module converts said fiber signals into said RF signals in said fiber to wireless stage; and wherein, in step (b), said RF transmitting module is coupled to said transmission path of said RF diplexer for transmission of said RF signals to said RF/packet converter in said fiber to wireless stage.

38. A method according to claim 37, wherein said RF transmitting module comprises an optical diode; wherein, in step (a), said optical diode optically transfers said fiber signals from the fiber network in said fiber to wireless stage; and wherein, before step (a), said method comprises a further step of (i) optically coupling said optical diode to a fiber optic cable of the fiber network.

39. A method according to claim 38, wherein, in step (b), said RF signals are successively filtered, amplified, attenuated, and re-amplified within said RF transmitting module before being transmitted to said transmission path of said RF diplexer, and before transmission of said RF signals to said RF/packet converter in said fiber to wireless stage.

40. A method according to claim 35, wherein, in step (b), a RF receiving module is coupled to said reception path of said RF diplexer for reception of said RF signals from said RF/packet converter in said wireless to fiber stage; wherein, in step (b), said RF receiving module converts said RF signals into said fiber signals in said wireless to fiber stage; and wherein, in step (a), said RF receiving module transfers said fiber signals to the fiber network in said wireless to fiber stage.

41. A method according to claim 36, wherein, in step (a), an optical diode of said RF receiving module optically transfers said fiber signals to the fiber network in said wireless to fiber stage; and wherein, before step (a), said method comprises a further step of (i) optically coupling said optical diode to a fiber optic cable of the fiber network.

42. A method according to claim 41, wherein, in step (b), said RF signals are successively attenuated, amplified, and re-attenuated within said RF receiving module before being converted into said fiber signals and transferred to the fiber network by said optical diode in said wireless to fiber stages.

43. A method according to claim 25, wherein, in step (f), an antenna diplexer/switch having a transmission paths a reception path, and a combined signal path bidirectionally transfers said analog signals over said combined signal path to and from the wireless network antenna.

44. A method according to claim 43, wherein, in step (d), a PHY processor electronically converts said data packets into said baseband digital signals; wherein, in step (e), a radio transmitting module receives said baseband digital signals from said PHY processor in said fiber to wireless stage, and converts said baseband digital signals into said analog signals; and wherein, in step (e), said radio transmitting module transfers said analog signals to said transmission path of said antenna diplexer/switch for transfer, in step (f), to the wireless network antenna in said fiber to wireless stage.

45. A method according to claim 44, wherein, in step (e), said baseband digital signals are converted into said analog signals, and said analog signals are successively mixed with a first oscillating signal, amplified, band pass filtered, re-mixed with a second oscillating signal, and power amplified within said radio transmitting module before being transferred to said transmission path of said antenna diplexer/switch in said fiber to wireless stage.

46. A method according to claim 43, wherein, in step (f), said analog signals are transferred, in said wireless to fiber stage, from the wireless network antenna to said combined signal path of said antenna diplexer/switch; wherein, in step (e), a radio receiving module transfers said analog signals from said reception path of antenna diplexer/switch in said wireless to fiber stage; wherein, in step (e), said radio transmitting module converts said analog signals into said baseband digital signals in said wireless to fiber stage, and transfers said baseband digital signals to a PHY processor; and wherein, in step (d), said PHY processor electronically converts said baseband digital signals into said data packets.

47. A method according to claim 46, wherein, in step (e), said analog signals are transferred, in said wireless to fiber stage, from said reception path of said antenna diplexer/switch to said radio receiving module, and said analog signals are successively filtered through a first band pass filter, low noise amplified, mixed with a first oscillating signal, re-filtered through a second band pass filter, re-amplified, and re-mixed with a second oscillating signal, before being converted into said baseband digital signals within said radio receiving module in said fiber to wireless stages.
